(19) United States
(12) Patent Application Publication
(10) Pub. No.: US 2006/0230113 A1
(43) Pub. Date: Oct. 12, 2006

(54) System and method for billing in a professional services information management system

(76) Inventors: Steven W. Lundberg, Edina, MN (US); Janal Kalis, Minneapolis, MN (US); Shal Jain, New Brighton, MN (US); Pradeep Sinha, Medina, MN (US); Thomas F. Brennan, Plymouth, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/085,626

(22) Filed: Mar. 21, 2005

(51) Int. Cl. G06F 17/30; G06F 15/16

(52) U.S. Cl. 709/206; 707/10

(57) ABSTRACT

According to various example embodiments of the inventive subject matter there is disclosed method and apparatus for receiving a message from an electronic mail handling system wherein a message is received in an intellectual property management system, and automatically associating the message with a legal matter represented in the intellectual property management system. Further there is displayed a user selectable item with the message when it is displayed to a user, wherein selection of the item brings a user to a data entry screen that accepts a time entry, and further also where the time entry is automatically associated with the legal matter in which the message is associated. In addition, the system and method provides for organizing intellectual property data according to activities related to intellectual property, wherein each activity is represented by an activity data structure containing at least some data pertinent to the activity, and wherein the activity data structure associates legal billing data associated with the activity. The system and method also provides for adding a legal services billing entry to an activity data structure using a user selectable item displayed while data associated with the activity data structure is displayed to a user.

### FIELD OF THE INVENTION

The invention relates generally to managing patent and trademark applications, and more specifically to a system for management of patent and trademark applications.

### COPYRIGHT NOTICE

This patent document contains copyrightable computer software elements including but not limited to source code, flow charts and screen displays. The following notice shall apply to these elements: Copyright© FoundationIP, LLC.

### LIMITED WAIVER OF COPYRIGHT

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND OF THE INVENTION

Patent agents and attorneys that specialize in patent prosecution typically draft dozens of patent applications per year, and are engaged in prosecution of many more. Each of these must be carefully tracked by the patent attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar.

But, when multiple attorneys are involved in docketed matters for multiple clients, when complex client or legal rules must be applied, or when corporate clients wish to participate in the docket management of matters on a law firm or attorney's docket, docket management using paper calendars and simple docketing software can become labor-intensive intensive and subject to errors. It is not uncommon for paper checklists of application drafting guidelines from clients, e-mail messages relating to a case, and multiple copies of docketing information to be kept separately for each patent or trademark application managed by an attorney or firm. Coordination and communication of this information is not a trivial task, and requires a significant amount of time and attention from the typical patent attorney or agent.

Attorneys increasingly use e-mail for most written communication with clients and others they work with. Keeping track of and recording the time taken to process these messages can be difficult due to the time required to do so and cumbersome data entry operations.

### SUMMARY OF THE INVENTION

According to various example embodiments of the inventive subject matter there is provided method and apparatus for sending or receiving a message from an external mail handling system or an internal one, wherein the message is received or stored in a data management system used by an attorney. The system provides for automatically associating the message with a legal matter represented in the intellectual property management system. Further there is displayed a user selectable item on the message when it is displayed to a user, wherein selection of the item brings a user to a data entry screen that accepts an attorney time entry, and further also where the attorney time entry is automatically associated with the legal matter in which the message is associated. In addition, the system and method provides for organizing intellectual property data according to activities related to intellectual property, wherein each activity is represented by an activity data structure containing at least some data pertinent to the activity, and wherein the activity data structure associates legal billing data associated with the activity. The system and method also provides for adding a legal services billing entry to an activity data structure using a user selectable item displayed while data associated with the activity data structure is displayed to a user.

### BRIEF DESCRIPTION OF THE FIGURES

FIG. 1 shows a web page from an Internet-based patent and trademark management system, consistent with an embodiment of the present invention.

FIG. 2 shows a messages web page, consistent with an embodiment of the present invention.

FIG. 3 shows a new tasks web page, consistent with an embodiment of the present invention.

FIG. 4 shows a new matters web page, consistent with an embodiment of the present invention.

FIG. 5 shows an organization view web page, consistent with an embodiment of the present invention.

FIG. 6 shows a templates web page, consistent with an embodiment of the present invention.

FIG. 7 shows an activities web page, consistent with an embodiment of the present invention.

FIG. 8 shows a user management web page, consistent with an embodiment of the present invention.

FIG. 9 shows a message list web page, consistent with an embodiment of the present invention.

FIG. 10 shows an activities web page, consistent with an embodiment of the present invention.

FIG. 11 shows an entities view web page for a selected matter, consistent with an embodiment of the present invention.

FIG. 12 shows an associated parties web page for a selected matter, consistent with an embodiment of the present invention.

FIG. 13 shows an IDS documents web page of data associated with a selected matter, consistent with an embodiment of the present invention.

FIG. 14 is a diagram illustrating features consistent with an embodiment of the present invention.

FIG. 15 is a flow chart illustrating features consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

In one embodiment of the invention, a web-based service provides a legal entity or a client or other affiliate of a legal entity access to data management functions to facilitate legal proceedings. A law firm may utilize the web-based system to track data for a client, such as patent and trademark status, docketing, documentation, and billing.

A client may be provided access to the web-based system, and when the client accesses the system is offered account setup functions which when selected enable the client to utilize the system to perform various functions separate from and optionally visible to the law firm. For example, an invention disclosure management module may be a part of the web-based service that is utilized by the client, but invention disclosures entered into and managed by the system will not be visible to the law firm until they are released to the law firm's attention. The client may therefore use the web-based system to store invention disclosures and use them for evaluation, budgeting, awarding of inventor stipends, or for other functions that are not initially or may never be visible to the law firm, as well as to record disclosure information that is selectively or entirely released to the attention of the law firm or to any other law firm.

Invention disclosure management in further embodiments includes a function for receiving invention disclosures and for time-stamping receipt of received disclosures for date of invention record verification purposes. Also, the invention disclosure module may comprise a facility so that reviewers of an invention disclosure may electronically witness and sign an invention disclosure, such that the signature of the signing witnesses is further date-stamped with data indicating the date of electronic signing.

The invention tracking module in some embodiments is further operable to track potential bar dates relating to national and international filing, based on data entered relating to an offer for sale, public use, publication, or other activities relating to the invention. The module provides notice at various dates to the client of nearing potential bar dates, alerting the client to the potential bar date and the action that must be taken to ensure rights are not lost.

The functions available to the client also include in some embodiments calendar or date tracking functions relating to various activities performed in the course of IP management, such as invention disclosure meetings, attorney meetings, technical review board meetings, etc., and if applicable further track decisions or results of these meetings such as whether to pursue a patent application relating to a specific invention disclosure.

One module of the web-based system usable for client data management, in one embodiment, comprises a data registry of various intellectual property held, such as records relating to trade secret identification and retention, a record of various trademarks and their uses and relevant registration or other legal information, and a patent portfolio log indicating issued patents and their various characteristics such as keyword and subject classification data such that a client may readily view and understand a record of his intellectual property holdings. In a further embodiment of the invention, the web-based system comprises a module operable to search the data relating to these various intellectual property assets, and to produce an intellectual property report or audit.

The client system will in some embodiments include a document system enabling creation or merging of various documents relating to intellectual property matters. License agreements, assignments, non-disclosure agreements, and other such legal documents are examples of documents that may be useful to clients and are included in the various embodiments of the invention.

The client's account data can be readily exchanged with the law firm via the web-management system in some embodiments, such that invention disclosure and potential bar date information relating to a case can be made available to the law firm once the decision to pursue a patent for a particular invention disclosure is made. In further embodiments, the web-based system provides issued patent or other reference search capability in various embodiments to the law firm and to the client for performing and documenting an electronic patentability search and review, so that results of a patentability search relating to an invention disclosure can be stored, and relevant documents recorded for preparation of an Information Disclosure Statement.

Further, in one embodiment, the law firm and the client are capable of exchanging other data via the web-based system, such as submission of a trademark, copyright, or trade secret matter for various purposes, as well as capability to track and coordinate data relating to other matters such as opinion-related issues and work. In one embodiment of the invention, these various intellectual property matters are identified to the client and to the law firm by a matter or activity identifier which need not be the same for both client and law firm, but which identify the same matter and enable identification and specification of data relating to the various matters in which the law firm and client are involved. In addition to matter identifier-based viewing of data, the web-based module in various embodiments comprises activity-based views in which an entity may view the various activities requiring attention for his various matters, may view all matters which have a certain activity pending, or may view another activity-based view of the intellectual property matters under management.

In some embodiments of the invention, the web-based systems used by the client and the law firm are the same computerized system, while in other embodiments they are separate computerized systems but are operable to exchange data as appropriate for proper operation of the invention as described in the above various examples. In some embodiments where the same system is used, various forms of encryption are used to ensure the confidentiality of data as it travels over the Internet or other network. In embodiments where a separate computerized system is utilized by the client, the client may install and configure his own computerized system to host a local web-based system consistent with the present invention such that the client's confidential information such as trade secret information and invention disclosures not released to external entities are held within systems under the client's control. Such systems will be able to exchange data with other computerized data management systems under the client's direction, and so provide the various functions discussed in the example embodiments of the invention presented herein.

Embodiments of the present invention can provide systems and methods for management of intellectual property information, legal information, and/or patent and trademark applications. Various embodiments are described herein with reference to the Figures.

The invention comprises in one embodiment a system for managing patent application data via the Internet, and comprises matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

### A Three-Tier Architecture

In some embodiments, the present invention can be thought of as a software application designed under a three-tier software architecture paradigm whereby various modules of computer code can be categorized as belonging to one, or more of these three tiers. A three-tier software architecture is well known in the art. (See Applying UML and Patterns: An Introduction to Object-Oriented Analysis and Design and the Unified Process 2^{nd} Edition, by Craig Larman, Prentice Hall, 2002.) The first tier is an Interface level that is relatively free of application processing. The second tier is a Logic level that performs processing in the form of logical/mathematical manipulations (Logical Manipulations) of data inputted, in some embodiments, through the Interface level, and communicates the results of these manipulations with the Interface and/or backend or Storage level. In some embodiments, these Logical Manipulations relate to certain business rules or tasks that govern the application as a whole. In some embodiments, these Logical Manipulations and associated business rules include: the purging of messages in a legal information system, the auto-filing of a result in an IP management system, the obtaining and disseminating of secured on-line data, generating work flow templates, regulating the export control of technical documents, the bulk downloading of documents, billing, creating and managing matter clusters, configuring certain activities, managing independent docket systems, prior art cross citations, and exchange public and private messages, just to name a few. The Storage level is a persistent, or, in some embodiments, a non-persistent storage medium. In some embodiments, one or more of these tiers is collapsed into another resulting in a two-tier architecture, or one-tier architecture. For example, the Interface and Logic levels may be consolidated, or the Logic and Storage levels may be consolidated as in the case of an application with an embedded database. This three-tier architecture may be implemented using one technology or, as will be discussed below, a variety of technologies. These technologies may include one or more object orient programming languages such as, for example, Java™, C++, Delphi™, C#™ or the like. Additional structured programming languages such as, for example, C may also be used. Moreover, scripting languages such as, for example, Perl, Python, PHP, JavaScript or VBScript may also be used. This three-tier architecture, and the technologies through which it is implemented, in some embodiments, can be embodied in two or more computers organized in a server-client relationship as is well known in the art. (See Computer Networking: A Top-Down Approach Featuring the Internet 2^{nd} Edition, James F. Kurose and Keith W. Ross, Addison-Wesley, 2003.)

### An Interface Level

In some embodiments, the present invention is implemented using a client based browser application. Some well known client based browser applications include Netscape Browsers™, Internet Explorer™, Mozilla Firefox™, or Opera™ just to name a few. Common to these browser applications, is the ability to utilize a hyper-text transfer protocol (HTTP) or secured hyper-text transfer protocol (HTTPS) to get, upload (i.e, PUT) or delete web pages and interpret these web pages which are written in a hyper-text markup language (HTML) and/or an extensible-markup language (XML). HTTP and HTTPS are well known in the art, as are HTML and XML. (See Id. XML for the World Wide Web, by Elizabeth Castro, Peachpit Press, 2000; Data on the Web: From Relations to Semistructured Data and XML 1^{ST} Edition, by Serge Abiteboul, Peter Buneman, & Dan Suciu, Morgan Kaufmann, 1999.) HTTP and HTTPS are, in some embodiments, used in conjunction with a TCP/IP protocol as described in the OSI model, or the TCP Protocol Stack model both of which are well known in the art. (See Computer Networking: A Top-Down Approach Featuring the Internet 2^{nd} Edition, James F. Kurose and Keith W. Ross, 2003.) The practical purpose of the client based browser application is to enable a user to interact with the application through the display of plain text, and/or interactive, dynamic functionality in the form of buttons, text boxes, scroll down bars or other objects contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages, in some embodiments, is a product of the use of other technologies in combination with HTML and/or XML.

In some embodiments, Java Server Pages (JSP™), or Active Server Pages (ASP™ or ASP.NET™) are use to provide a user with dynamic web pages or content via their web browser. In some embodiments, additional technology in the form of an additional program (i.e, routine) written in another programming language is embedded into the HTML and/or XML code allowing for the web pages to become dynamic. Some of these additional technologies include, for example, embedded routines written in the Java™ programming language, the Java Script language, or the Visual Basic™ Programming Language, just to name a few. In some embodiments, these embedded routines are used to execute the aforementioned HTTP, HTTPS requests (i.e., GET, PUT, and DELETE) for web pages. Various types of programming structures such as branches, loops and other types of logic structures are used in such routines. These routines may, in some embodiments, allow a user to login, and request content or upload content.

In some embodiments, a graphical user interface (GUI) is used and is implemented via a Java Servlet, Applet, or VBScript form just to name a few. As will be discussed below, web pages containing GUIs are, in some embodiments, stored at the logical level, but executed at the Interface level via a web browser. These web pages contain objects such as text boxes, buttons, scroll-down bar, just to name few. These objects, and the routines governing them, allow a user to retrieve, input, or delete content just to name a few of the functions. For example, in some embodiments, a user will be prompted with a login page requesting username and password information to be entered into two or more text boxes. Once the data entered into the text boxes is verified, a second, new web page will be requested, interpreted and displayed in the browser application. The verification of the login information will take place at the Logic level outlined below.

### A Logic Level

In some embodiments, the above described Servlet, Applet and/or VBScript form are stored as a JSP™, or ASP™ on one or more remote server computers connected to the client computer via an internet. These remote servers can, in some embodiments, be a web server and/or application server. In some embodiments, web servers running JSP™ can include the Apache™/Apache™ Tomcat web server. In some embodiments, web servers running ASP™ can include Microsoft Windows Web Server 2003™. In some embodiments, application servers running JSP™ can include an Orion Application Server, or J2EE™ Application Server just to name a few. In some embodiments, application servers running ASP™ can include Windows Server 2003™.

In some embodiments, the Logic level is governed by a scripting language that controls how and when certain web pages or pieces of content are provided to, or made accessible to a particular user. This scripting language can be in the form of Java™, Perl, Python or some other general purpose scripting language. For example, once the logic of a JSP™ determines that a particular object (e.g., a text box) on web page has been executed (e.g., a username and password is entered and sent), the data from this text box is inputted, sent to the web or application server. In some embodiments, it is the logic of a routine written in a scripting language that determines what will be sent to the user upon the successful verification of the username and password. In some embodiments, it is the routine written in a scripting language that determines whether, for example, the username and password are valid. In some embodiments, the routine written in a scripting language will serve to retrieve data from a storage, data structure or database level. In some embodiments, the storage level will be a run by a separate database application, while in other embodiments a database embedded with a Logical level will be implemented.

### A Storage Level

In some embodiments, a storage level is implemented whereby tables of data are created, and data inserted into or selected from these tables using a Structured Query Language (SQL) or some other database related language known in the art. (See The Fundamentals of Database Systems 3^{rd} Edition, by Remez Elmasri & Shamkant B. Navathe, Addison-Wesley, 2000.) These tables of data can be managed using a database applications such as, for example, MySQL™, SQL Server™, or Oracle 9i™ or 10g™ just to name a few. These tables, in some embodiments, are organized into a relational-database schema (RDS) or object-relational-database schema (ORDS) as is known in the art. (See id.) In some embodiments, these schemas can be normalized using certain normalization algorithms so as to avoid abnormalities such as non-additive joins and other problems. In some embodiments, these normalization algorithms include Boyce-Codd Normal Form or some other normalization, optimization algorithm known in the art. (See id.) For example, in some embodiments, username and associated password information are stored together such that the scripting routine can compare the inputted, received username and password information to that data stored in the database.

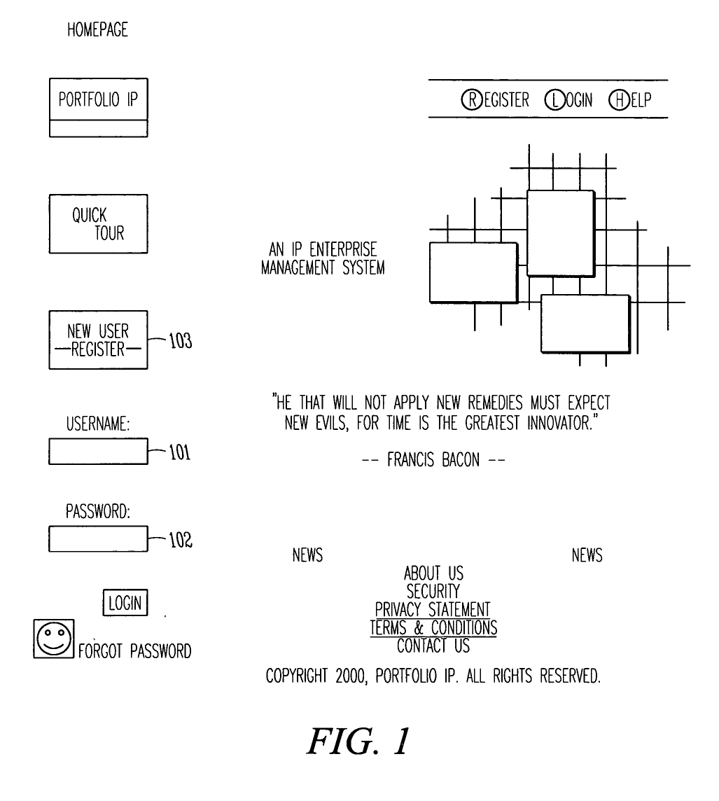

FIG. 1 illustrates one embodiment of a front World Wide Web (WWW) web page of a system consistent with the present invention. A user will log in to the example system shown here by entering a user name at 101, and a password at 102. If a prospective user does not have an account but wishes to create one, the user may do so by selecting to register at 103.

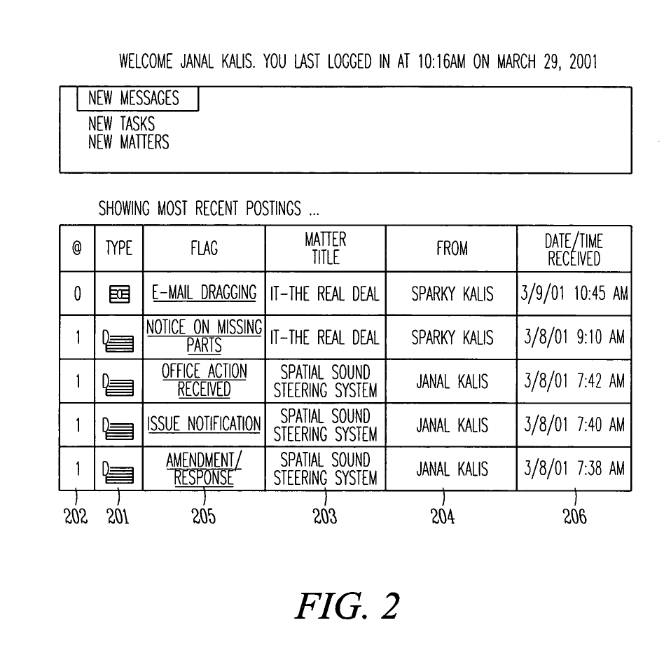

Upon logging in, the user is presented with a home screen presenting the user with various options. For example, the user may be presented with or may select to view his new messages, as is shown generally in FIG. 2. Each message as shown in FIG. 2 includes a message type represented by an icon at 201, an indication of the number of attachments to the message at 202, a matter title indicating a matter related to the message at 203, an indication of who the message is from at 204, a message title at 205, and the time and date the message was received at 206. The user may select a message to view the message, may select a user to send a reply message to the user, may select the message title to display the message, may select the number of attachments indicator to view the attachments, or may take other actions in response to the mew messages screen shown in FIG. 2.

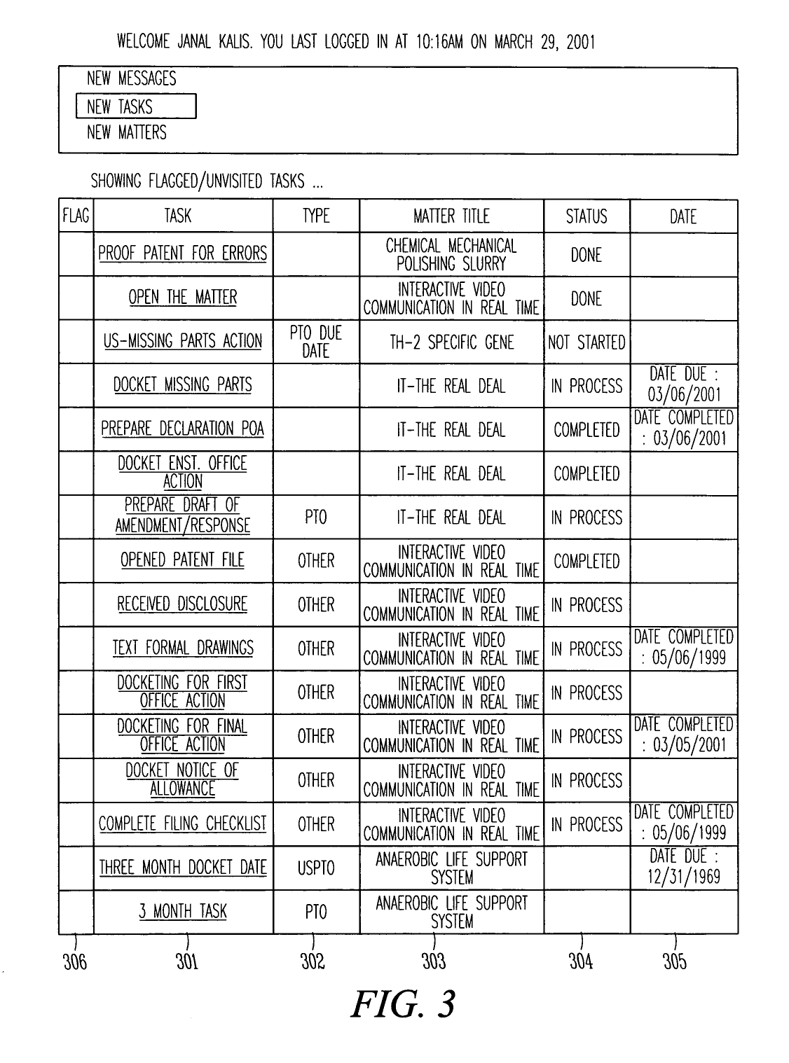

The user may also be presented with or select to view a new tasks screen as shown in FIG. 3, which illustrates new tasks associated with the particular logged in user. Each task has associated data that is displayed in the new tasks view, including the task name at 301, the type of task at 302, the title of the matter the task is related to at 303, the status of the task at 304, and a date associated with the task if appropriate at 305. Tasks may be flagged as shown at 306, so that a user may elect to view only flagged tasks or only new and flagged tasks, thereby viewing a subset of tasks that are of higher importance to the user.

In some embodiments of the invention, the user will be able to generate similar task lists, where the lists are limited to or sorted by client, by date due, by date completed, by status, by type, or by other similar criteria.

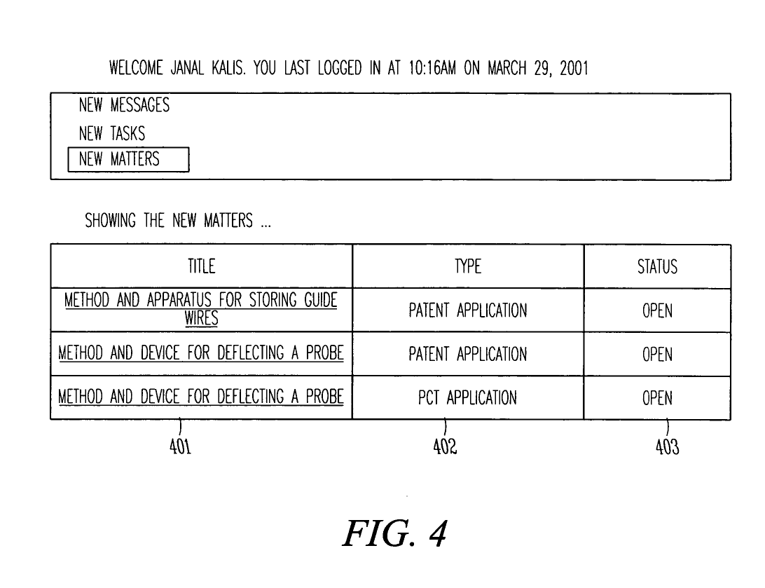

Users may also elect from the home page of the example embodiment of the invention described here to view new matters, as shown in FIG. 4. The title of each new matter is shown at 401, and the type of matter is shown at 402. The matter status is shown at 403, and additional matter material may be shown in further embodiments of the invention. As with tasks, users may also view in further embodiments of the invention other matter summary views similar to the one shown in FIG. 4, such as a view of all matters relating to a particular client, all matters with tasks due during a certain time period, all matters with a certain matter status, or any other such customized matter view.

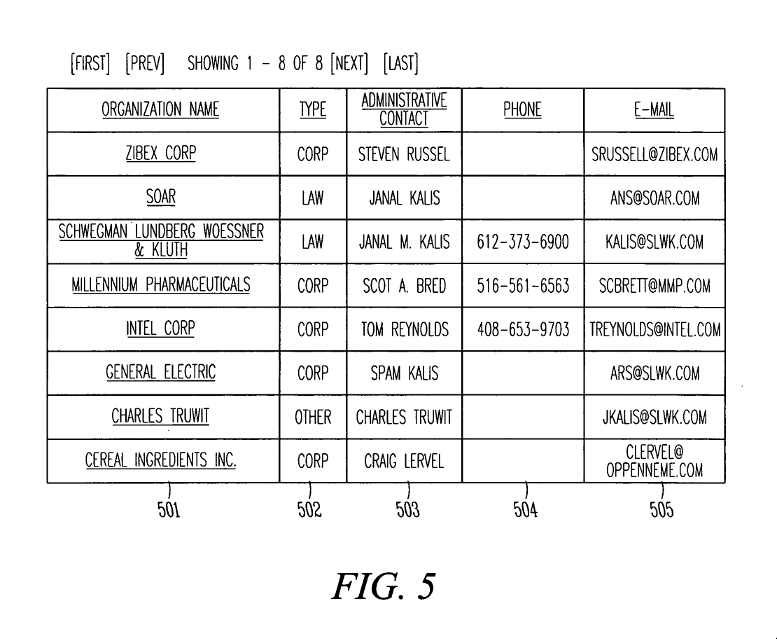

Matters and users may be associated in some embodiments of the invention with organizations, such as with particular client companies or particular law firms. These organizations are managed by the example embodiment of the system discussed here as is shown in FIG. 5. Each organization is identified by name as shown at 501, and has a type associated with it to identify the nature and role of the organization. The contact or agent for each organization is shown at 503, along with a contact phone number 504 and e-mail address 505 for each contact. Organization data may in some embodiments of the invention be edited or added only by system administrators, and in further embodiments select members who are part of an organization will be given authority to edit existing organization data.

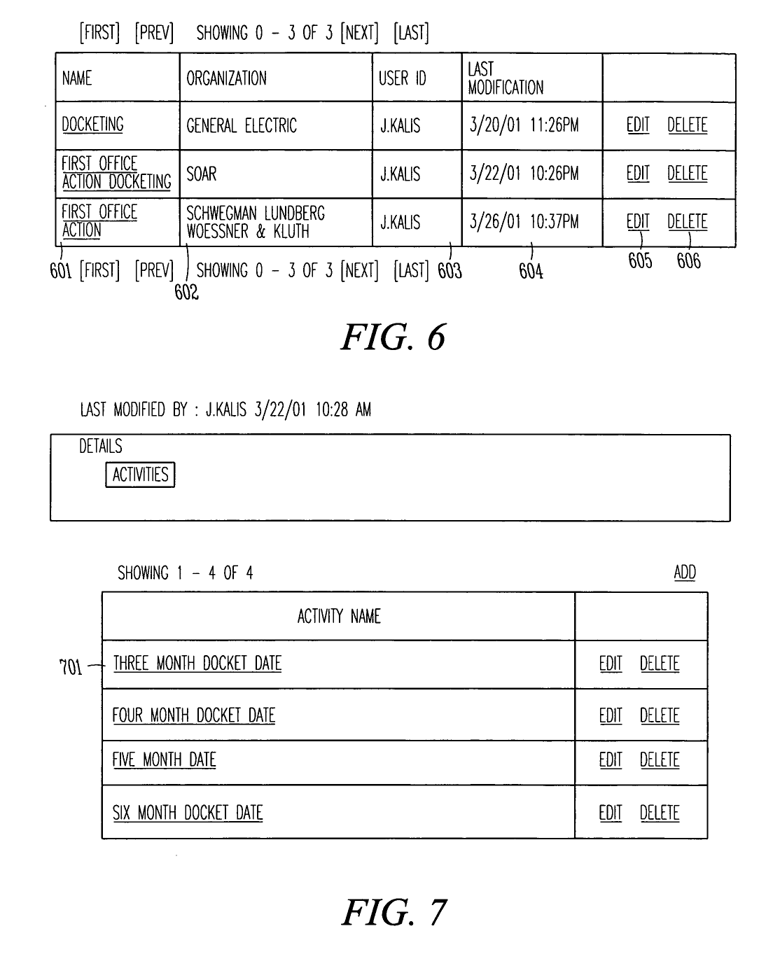

Tasks may be created for matters by manually entering tasks, or in some embodiments of the invention may further be created automatically via templates or other predefined task generation utilities. FIG. 6 illustrates a view of templates available for application to matters in one embodiment of the invention. The template name is shown at 601, and the organization associated with the template is shown at 602. The last modification of the template is reflected at 603 and 604, where the modifying user's identity and the date and time of the last modification are shown. The user has the option to delete existing templates as shown at 606, to create new templates, or to edit existing templates as shown at 605.

Templates include such items as creating checklists to ensure proper drafting criteria are met, creating tasks with associated dates such as deadlines for responses, and other similar tasks that are common to many applications and have predictable elements. For example, a client may request that a certain checklist of drafting criteria be completed before each filing, and the checklist may be implemented as a task associated with each of the client's matters via use of a template. Also, creation of docket dates and tasks associated with those dates in a system such as the present invention may be automatically calculated and created by a template, ensuring proper application of applicable rules. Many other such examples of tasks common to many applications with predictable elements exist, and all are within the scope of the template function as implemented in the example of the present invention presented here.

FIG. 7 illustrates the activities that are associated with an amendment and response to a typical United States Patent and Trademark Office issued Office Action. The typical shortened statutory three-month date for response is shown as an activity item at 701, and is followed by subsequent deadlines for taking each allowable extension of time past that date. These items will then automatically be added to the task list of each matter to which the template is applied, creating appropriate task entries for that matter.

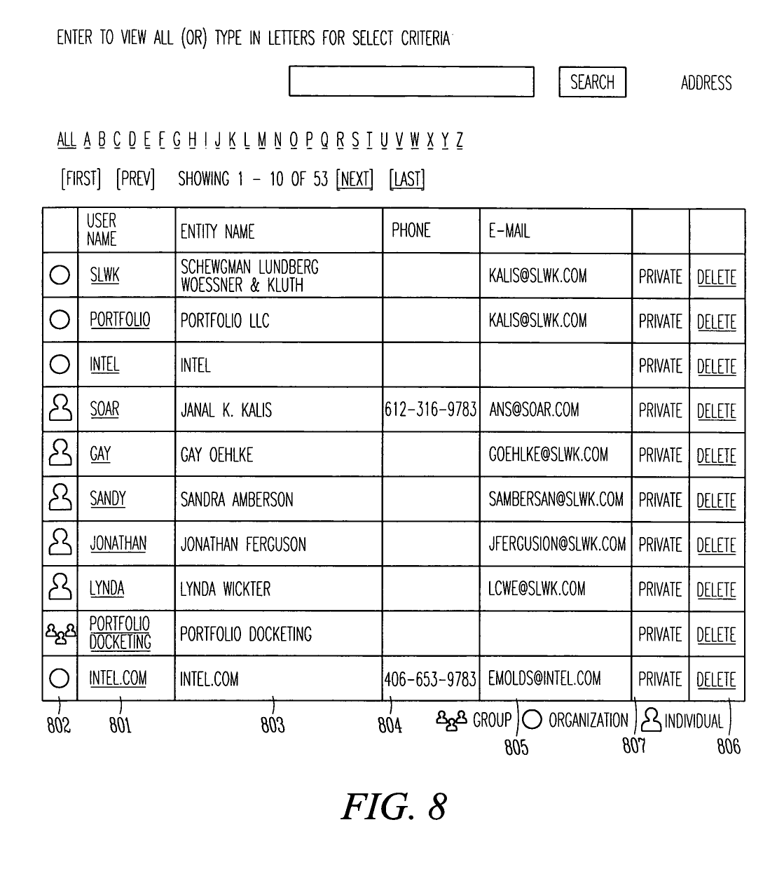

FIG. 8 illustrates a user management view of all users that have registered with the embodiment of the present invention described here. The user name or alias is shown at 801, the entity type is shown at 802, the full name of the entity is shown at 803, and contact information including phone and e-mail are shown at 804 and 805. The user management screen shown here allows a system administrator to delete users at 806, and indicates the source of the user at 807.

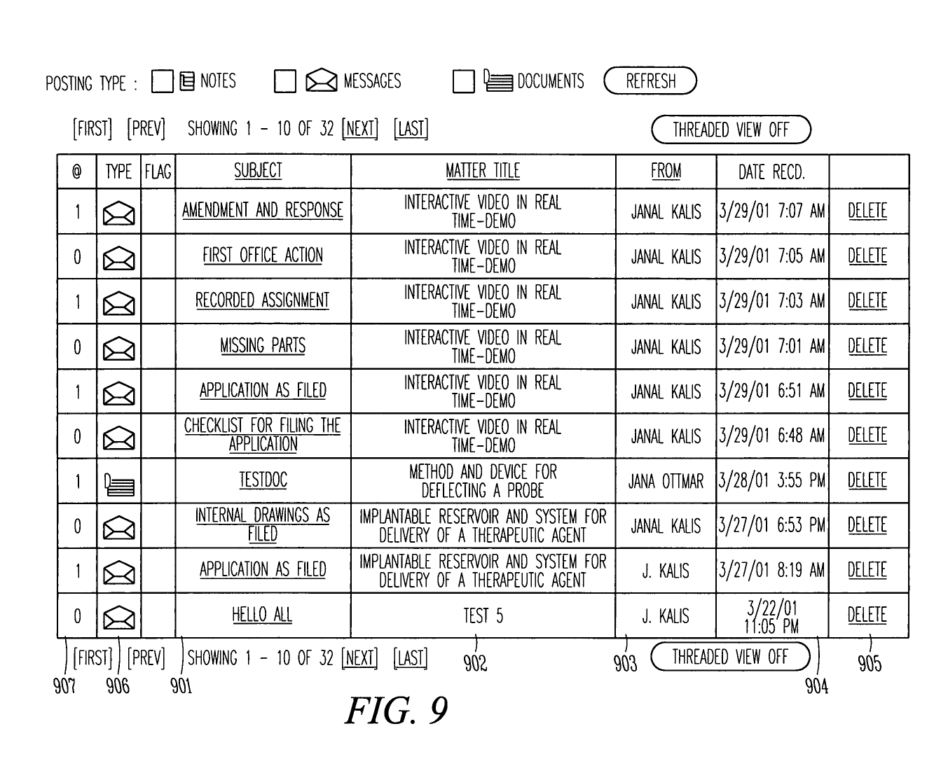

An example message list is shown in FIG. 9, which illustrates a variety of messages for a particular user. The subject or name of the message is shown at 901, and the title of the matter to which the message pertains is shown at 902. The sender of the message is shown at 903, and the date the message was received is shown at 904. At 905, the user is shown a Delete object that may be selected to delete the associated message. The type of message is indicated at 906, and the number of attachments to the message are shown at 907. Note that in this example, several automatically generated messages such as reports of actions completed or docket dates are shown in the message box.

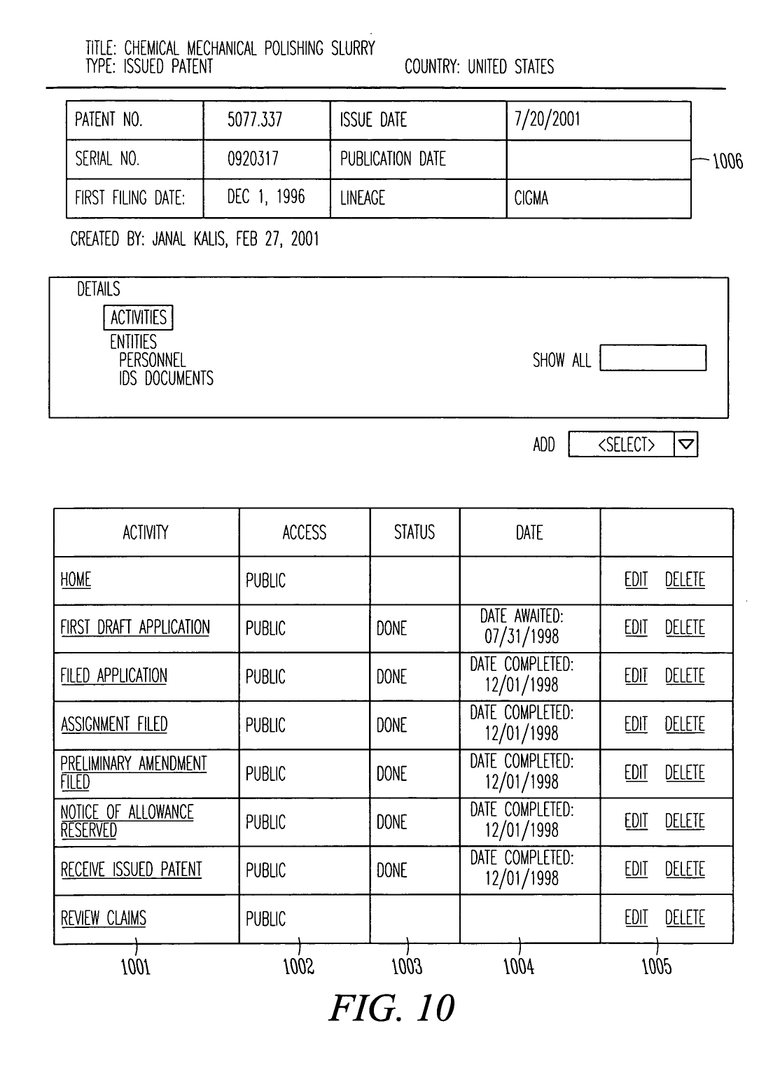

FIG. 10 shows a view of tasks or activities associated with a particular matter. The activity is shown at 1001, and is selectable by the user. Selecting the activity by name will open the detail list for that particular activity. Any restrictions on access to the activity are shown at 1002, and the status of the activity is shown at 1003. Relevant dates for the activity, which may vary in type depending on the activity status, are shown at 1004. At 1005, the user may edit or delete listed activities. Because the matter shown here is an issued patent, the patent number, issue date, and other information are known and are displayed at 1006 in a matter page header.

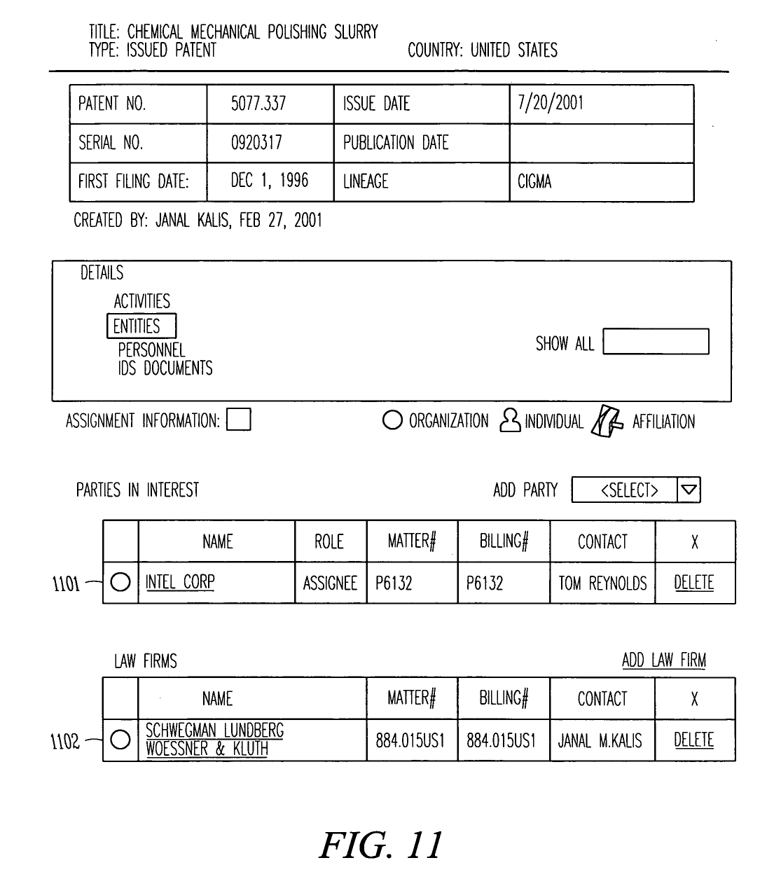

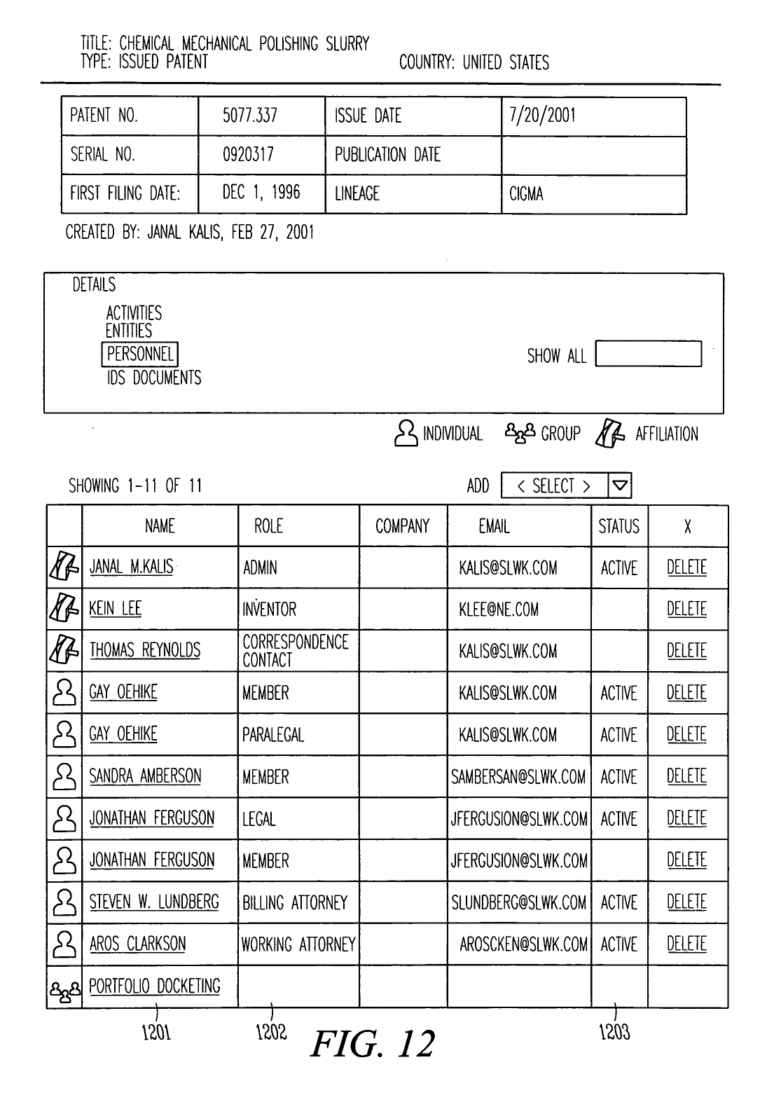

FIG. 11 shows an entities view of a particular selected matter. The parties in interest in this example comprise Intel Corp., as shown at 1101. The law firm associated with the matter is shown at 1102.

The embodiment of the invention shown here also shows additional associated parties, such as corporate counsel responsible for overseeing the matter, the attorney and paralegals involved with the case, and other users or entities involved with the matter. This is shown in FIG. 12, where the associated users are listed at 1201. The role each user has in the matter is shown at 1202, and the status of the user is shown at 1203. Note that a user may be invited to join a matter, but is not listed as active in this embodiment of the invention until the user takes affirmative steps to join in a matter.

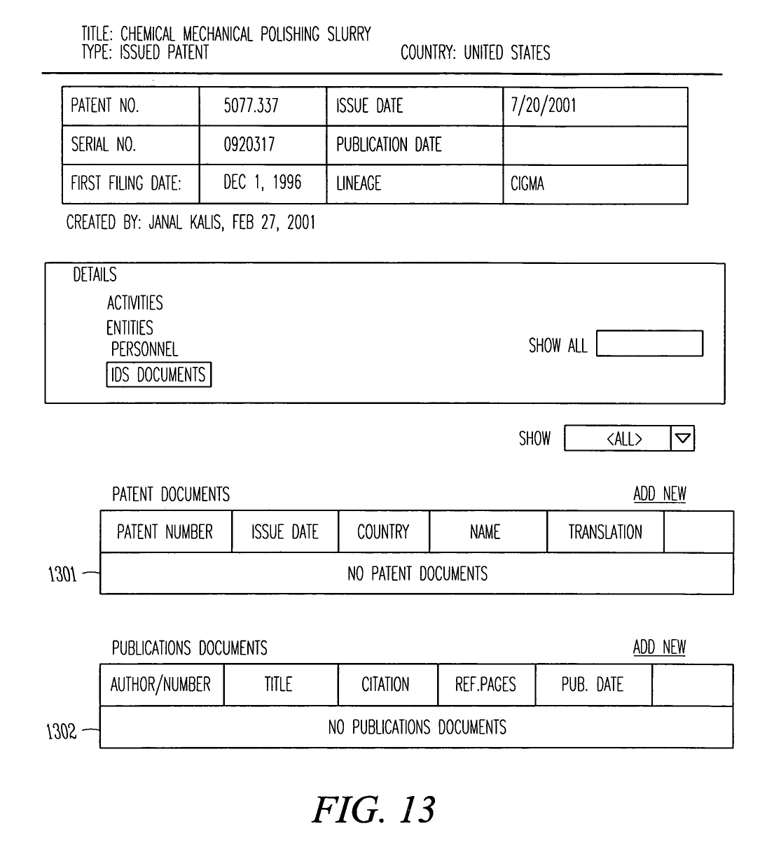

FIG. 13 is an IDS documents view of data associated with a matter, and shows documents that must be disclosed in an Information Disclosure Statement or IDS to the USPTO. Because no documents have been associated with this example matter, none are illustrated here. For patent documents that must be cited, the patent number, issue date, country of issue, name, and translation are shown at 1301. For documents that are not patent documents but are other publications, the author's name, document title, citation, referred pages, and publication date are recorded and are shown at 1302.

The example embodiment of the present invention explained above and in the figures is further described in the following use case, which describes ways in which the functionality of the present invention may be used by various users and organizations to facilitate more efficient management of a patent or trademark docket.

The use case system will be used in a decentralized way as a web-based application where multiple law-firms and corporations, as well independent lawyers and consultants, can all come together to collaborate on patents in which they are involved.

The service provider will deal with various law-firms and corporations to create a community where patents filing process can be vastly streamlined. All such law firms and corporations (referred to as ‘Business entities’) will be dealing directly with the service provider (sending all the materials to be scanned, etc. to them). There will be an administrator at the service provider, who will be to verify business entities details and assign them a account number (provided by our system).

The business entities will assign an account administrator who will be responsible for managing who participates on behalf of the entity in the patent process. The business entity does this by sending an invitation to a prospective participant with an access code that allows him to access information relating to the business entity. In this process, the administrator may also authorize such participant to charge matter and other related costs to specified account number. Membership in groups is regulated such that anyone can create a user account and associated login. This person can then create a new matter to be managed via the service provider's web site, and can specify other participants for that matter. The service provider then sends e-mail to these invited participants with an invitation to join and a password or secure link. An invitee can then log in, and select to access the matter from his matters list, and supply a password received in the e-mail to associate the new matter with his particular user account and matters list. One example involves an attorney who logs on, opens a new matter, then sends invitations to inventor, paralegals, etc. For each one of these, he provides an email address to which an invitation is sent, and a password with which the invited users can access the matter. Inventor gets email with a site URL, matter number and password. When he clicks it, he is required to sign in. When he gets to my matters, he presses ‘Access New Matter’ button, which asks him for matter number and password. He fills in this information from what he received by email. This matter is now made available on his matter list.

In a second example scenario, Thomas Edison signs up with the service, and creates a new matter. He fills in notes regarding the invention and other information, and finally decides on an attorney or law firm to work with. He sends invitations to selected attorneys there. The attorney accepts the invitation, and then sends out additional invitations to paralegals and other associated users.

In a third scenario, Idle Joe signs up, and goes to ‘My matters’. He sees nothing there. He cannot access any existing matters to which he has not been invited. He opens a new matter, and plays around with the functions provided by the website. He realizes there's nothing at the service provider for him, then logs off and goes on to cause trouble elsewhere. New users who do not have any associated matters and are not members of any group will periodically have their accounts deactivated to ensure smooth operation of the service provider system.

This use case example further provides billing functionality. The service provider provides the option of billing for each open matter, and allows creating billing entries for services associated with a matter, such as docketing, prior art searches, drafting, drawing preparation, or other related services or products.

The service provider's system is configured such that the entities that interact with the system are categorized into individuals, businesses, clients, law firms, the USPTO, and the service provider, as explained in greater detail below.

Individuals includes ordinary individual users who could be attorneys working for a law-firm, independent attorneys, employees of corporations, independent consultants, paralegals, etc. In short, it includes any person who is involved or expected to be involved in the managing of a matter through to completion.

Business entities allows several individuals to participate in the process under the same umbrella. Two types of Businesses are recognized: Client, and Law Firm businesses. A Client participates as a requester of patent services and law firm acts as provider of such services.

Clients are the entities that are seeking patent services. The client can be a corporation, university, or other entity, and essentially defines a grouping of individuals who can share information that is common to them by virtue of their association with the client entity. For example, a corporation will have a preferred set of law firms, a preferred set of foreign associates, and other preferences and relationships. An account administrator for the corporation can assign privileges to different people for different pieces of information associated with the Corporation.

A law firm is a grouping of individuals, including lawyers, paralegals, and other individuals who can share information common to them by virtue of their association with a legal services provider. For example, lists of client companies and information about individuals within them is information may be accessible to various degrees throughout a law firm. A law firm administrator can invite people to be members of the law firm group and give privileges to them for access to various information.

Still other entities may be created and invited to participate in a matter to facilitate patent legal services. The United States Patent and Trademark Office and select examiners may be given certain access to relevant matters, outside service providers such as scanning service providers may be given access to certain data, and the service provider operating the website may have varying degrees of access to data.

The service provider will desirably manage the various accounts and grouping of entities, and provide customer support for the various services and functions of the website. The service provider will not only have access to certain data, but will be able to determine billing for services provided via the website, account information of the member entities, and will have account management capability.

The various matters managed via the service provider include a client name, a client contact name, a law firm or service provider name, a law firm matter number, a client reference number, a unique reference number provided by the service provider, a foreign associate for various corresponding foreign filings, and identification of the various law firm members assigned to the matter. Law firm roles include billing attorney, working attorney, signature attorney, paralegal, docketing specialist, IDS specialist, and various secretaries that may be associated with the other law firm members.

Individuals can have one or more roles in a client organization, and may belong to several organizations or groups via a single user name or login ID. It is anticipated that a typical individual will serve various roles in a number of different matters, and will have access via a single login or user ID to information related to each of the various matters with which he is associated.

Business entities may further have approved lists of law firms, foreign associates, and other approved entities. Individual attorneys may also be approved, and lists of individuals working with the business entity matters within other entities may be used.

For this use case example, assume an administrator representing a business or corporate entity desires to use the service provider to manage patent-related legal services. The administrator creates a new account within which matters created by its approved members can be created, managed, and billed. The business account manager can add new law firms, attorneys, foreign associates, business representatives, inventors, and other members. The business account administrator can further deactivate or remove various members from the business account or matters owned by the business account, and can generate reports and retrieve information relating to the various matters and entity involvement in the matters owned by the business account.

A law firm entity will have the ability to create new client records, including invitation to business entities to join matters or create accounts. The law firm will also have the ability to enter billing and fee data, including calculation of fees for particular services or hourly rates, and entry of fee codes and billing descriptions. The law firm further can invite new users to be members of the law firm, assign users to roles within specific matters, and manage the role of various users within the law firm and within matters with which the law firm is associated.

Individuals will be able to join existing business groups, law firms, or other entities with the approval of the entity. Association with an entity may be ad the individual's request, or by invitation from the entity. Each individual, whether a member of another entity or not, will be able to create matters, invite others to participate in the matters, receive and send e-mail regarding the matters, and view the status of his matters. The individual can create or update notes associated with his matters, check outstanding actions or dates for his matters, generate matter reports, print documents, and browse other information relating to his matters. This information includes viewing invited and associated entities for each matter, viewing matter task information, viewing billing or invoice information, viewing related case information, and viewing docketing information.

The individual will also be able to copy, delete, remove, archive, or verify matters, and will be able to search for matter information via law firm docket number, client name, serial number, prior docket number, related case number, inventor name, and other information. The matters will have a notes or discussion area for maintaining matter-related notes, and will have data records enabling automated e-mail reminders of actions due and case status.

Trademarks may be managed as matters, and will have information including the actual trademark sought, action data, country-related data, conflict opposition data, auxiliary files or tables, reports, recurring date menus, utility menus, agent details, and country details. Managed patents will similarly have record space configured for storing invention or disclosure data, country application data, actions due or docketing data, auxiliary files and tables, reports, maintenance fee data, utility menus, actions menus, and cost tracking and budgeting data.

Information disclosure statement (IDS) records are associated with various other matters such as filed or unfiled patent applications, and are managed via functions that include the ability to copy documents to or from other matters to which the user has access, to delete or add documents associated with a particular matter, to combine references cited from various matters, to scan or view images of various references, to view US patent documents by patent number, title, or other identifier, to view foreign patent documents, to view non-patent documents, or to view all associated documents. Documents associated with an IDS may be marked as relevant or not relevant, or may be unmarked. The documents associated with an IDS for a particular matter may therefore be viewed, printed, merged, sorted, or otherwise managed based on whether they are marked relevant, marked not relevant, or unmarked.

Marked documents may be merged into forms such as a standard form 1449 for citing relevant known art to the USPTO. Documents that have been cited are marked separately from those that have been marked but not yet sent, to enable accurate tracking and determination of which documents have been cited and which documents are yet to be cited.

Each IDS reference document will have associated records that enable accurate identification of the document, such as US patent number, foreign patent number, issue date, priority date, inventor names or author names, publication name or other citation of non-patent publications, and title. It is desired that the records associated with each IDS reference be sufficient to meet the formal reporting requirements in citing the document to the USPTO via a form 1449 or other appropriate method.

Some members, such as scanning centers, may have very limited capabilities relative to a typical member or entity. A scanning center, for example, may be limited to uploading scanned data to be associated with a particular matter, entering billing or invoice charges and descriptions, and generating reports of uploaded data and billing charges.

Finally, in a use case such as that described here, a business entity or other client can easily change law firms, attorneys, or the role of other members in various matters managed via the service provider with minimal effort or expense.

### System and Method for Billing

Embodiments of the present invention provide a system that allows for the economic recovery of professional service costs associated with electronic communications. As an example, the transformation of the legal profession from traditional paper-based communication to electronic communications creates difficulty in accurately billing for an attorney's service time reading and writing e-mails.

In the inventive data processing system, as described above with reference to intellectual property services, the data is organized according to activities related to intellectual property. Each intellectual property activity is represented by an activity data structure containing at least some data pertinent to the activity, such as professional services billing.

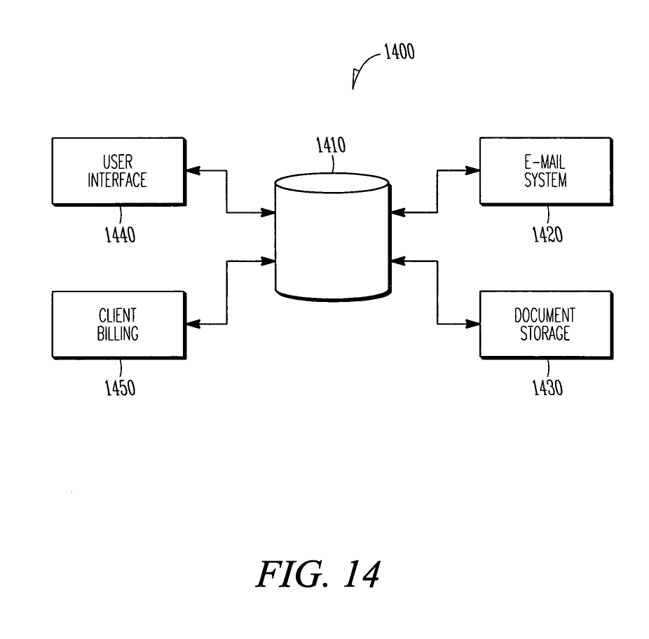

Referring to FIG. 14, a system 1400 having a data management system 1410 can process e-mails and store documents 1430, as explained above. A user interface 1440 allows users to access the data system. In one embodiment of the present invention electronic messages, or e-mails, can be sent or received from a mail handling system 1420 such that the message is received or stored in a data management system. For example, the data management system may be implemented by an attorney or professional legal service. The embodiment provides for automatically associating the message with a matter represented in the data management system, as described above in greater detail. The email communications are processed to allow automatic billing for clients 1450.

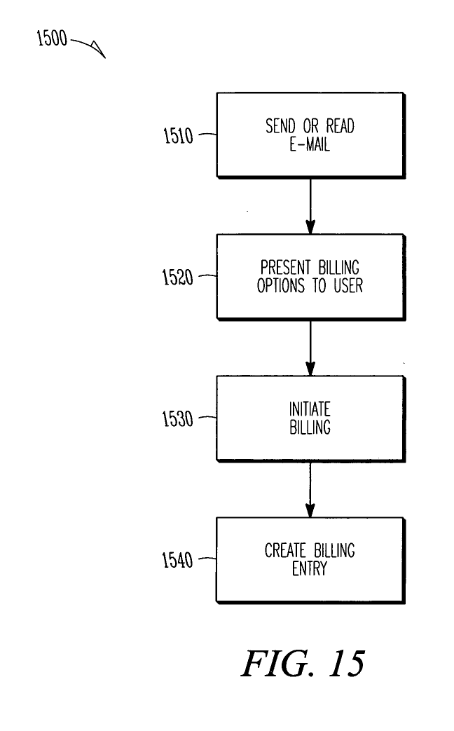

In one embodiment 1500, as illustrated in FIG. 15, when an e-mail is written, sent or received 1510 the data management system displays a user selectable item. For example, a selectable icon (generically referred to as an item) is displayed on a computer monitor screen that the user can activate. The item is displayed during drafting of an e-mail, upon sending the e-mail and/or when an external e-mail is received. Upon activating the item a data entry routine, or operation, is executed that presents a data entry screen to the user 1520. Billing is initiated either manually or automatically 1530 to create a billing entry 1540 in the management system. The data entry screen allows the user to enter and edit professional billing information. For example, in the legal profession embodiment attorney time associated with electronic correspondences can be entered into the data base and automatically associated with the legal matter in which the electronic message is associated. In yet another embodiment, a billing code is associated with the billing entry. For example, a ‘reading e-mail’ or ‘preparing e-mail’ billing code is associated with the appropriate billing entry.

The above described embodiments of the present invention allow for fast accurate real-time entry of professional service fees associated with processing electronic communications.

Although specific embodiments of the present invention have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

### Marked-Up Copy of Original Specification

### CLAIM OF PRIORITY

This application claims priority from: “Internet-Based Patent and Trademark Application Management System”, Steven W. Lundberg, Inventor, Ser. No. 09/872,701, filed Jun. 1, 2001, which claims priority to “Internet-Based Patent and Trademark Application Management System”, Ser. No. 60/280,386, filed Mar. 29, 2001; “Internet-Based Patent and Trademark Application Management System”, Steven W. Lundberg, Inventor, Ser. No. 10/741,166, filed Dec. 17, 2003, which claims priority to “Internet-Based Patent and Trademark Application Management System”, Ser. No. 60/433,935, filed Dec. 17, 2002; and “METHODS, SYSTEMS AND EMAILS TO LINK EMAILS TO MATTERS AND ORGANIZATIONS”, Sinha et al inventors, Ser. No. 10/128,141, filed Apr. 23, 2002 which claims priority to “A SYSTEM FOR SENDING AND RECEIVING ELECTRONIC MESSAGES IN AN ENTERPRISE MANAGEMENT SYSTEM”, Ser. No. 60/285,842, filed Apr. 23, 2001 and “SYSTEM, FUNCTIONAL DATA, AND METHODS FOR ON-LINE COLLABORATING USING MESSAGING, REPORTING, SECURITY, DOCKETING, BILLING, AND DOCUMENT MANAGEMENT”, Ser. No. 60/335732, filed Oct. 18, 2001. The entire contents of the above cited applications are hereby incorporated herein by reference.

### Source Code Appendix

A compact disc (CD) appendix including source code and other program elements is included herewith. The entire contents of the CD are hereby incorporated herein by reference. The names of the files contained on the compact disc, their date of creation and their sizes in bytes are listed in Appendix A.

### FIELD OF THE INVENTION

The invention relates generally to managing patent and trademark applications, and more specifically to a system for management of patent and trademark applications.

### COPYRIGHT NOTICE

This patent document contains copyrightable computer software elements including but not limited to source code, flow charts and screen displays. The following notice shall apply to these elements: Copyright© FoundationIP, LLC.

### LIMITED WAIVER OF COPYRIGHT

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND OF THE INVENTION

Patent agents and attorneys that specialize in patent prosecution typically draft dozens of patent applications per year, and are engaged in prosecution of many more. Each of these must be carefully tracked by the patent attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar.

But, when multiple attorneys are involved in docketed matters for multiple clients, when complex client or legal rules must be applied, or when corporate clients wish to participate in the docket management of matters on a law firm or attorney's docket, docket management using paper calendars and simple docketing software can become labor-intensive and subject to errors. It is not uncommon for paper checklists of application drafting guidelines from clients, e-mail messages relating to a case, and multiple copies of docketing information to be kept separately for each patent or trademark application managed by an attorney or firm. Coordination and communication of this information is not a trivial task, and requires a significant amount of time and attention from the typical patent attorney or agent.

Attorneys increasingly use e-mail for most written communication with clients and others they work with. Keeping track of and recording the time taken to process these messages can be difficult due to the time required to do so and cumbersome data entry operations.

### SUMMARY OF THE INVENTION

According to various example embodiments of the inventive subject matter there is provided method and apparatus for sending or receiving a message from an external mail handling system or an internal one, wherein the message is received or stored in a data management system used by an attorney. The system provides for automatically associating the message with a legal matter represented in the intellectual property management system. Further there is displayed a user selectable item on the message when it is displayed to a user, wherein selection of the item brings a user to a data entry screen that accepts an attorney time entry, and further also where the attorney time entry is automatically associated with the legal matter in which the message is associated. In addition, the system and method provides for organizing intellectual property data according to activities related to intellectual property, wherein each activity is represented by an activity data structure containing at least some data pertinent to the activity, and wherein the activity data structure associates legal billing data associated with the activity. The system and method also provides for adding a legal services billing entry to an activity data structure using a user selectable item displayed while data associated with the activity data structure is displayed to a user.

### BRIEF DESCRIPTION OF THE FIGURES

FIG. 1 shows a web page from an Internet-based patent and trademark management system, consistent with an embodiment of the present invention.

FIG. 2 shows a messages web page, consistent with an embodiment of the present invention.

FIG. 3 shows a new tasks web page, consistent with an embodiment of the present invention.

FIG. 4 shows a new matters web page, consistent with an embodiment of the present invention.

FIG. 5 shows an organization view web page, consistent with an embodiment of the present invention.

FIG. 6 shows a templates web page, consistent with an embodiment of the present invention.

FIG. 7 shows an activities web page, consistent with an embodiment of the present invention.

FIG. 8 shows a user management web page, consistent with an embodiment of the present invention.

FIG. 9 shows a message list web page, consistent with an embodiment of the present invention.

FIG. 10 shows an activities web page, consistent with an embodiment of the present invention.

FIG. 11 shows an entities view web page for a selected matter, consistent with an embodiment of the present invention.

FIG. 12 shows an associated parties web page for a selected matter, consistent with an embodiment of the present invention.

FIG. 13 shows an IDS documents web page of data associated with a selected matter, consistent with an embodiment of the present invention.

FIG. 14 is a diagram illustrating features consistent with an embodiment of the present invention.

FIG. 15 is a flow chart illustrating features consistent with an embodiment of

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

In one embodiment of the invention, a web-based service provides a legal entity or a client or other affiliate of a legal entity access to data management functions to facilitate legal proceedings. A law firm may utilize the web-based system to track data for a client, such as patent and trademark status, docketing, documentation, and billing.

A client may be provided access to the web-based system, and when the client accesses the system is offered account setup functions which when selected enable the client to utilize the system to perform various functions separate from and optionally visible to the law firm. For example, an invention disclosure management module may be a part of the web-based service that is utilized by the client, but invention disclosures entered into and managed by the system will not be visible to the law firm until they are released to the law firm's attention. The client may therefore use the web-based system to store invention disclosures and use them for evaluation, budgeting, awarding of inventor stipends, or for other functions that are not initially or may never be visible to the law firm, as well as to record disclosure information that is selectively or entirely released to the attention of the law firm or to any other law firm.

Invention disclosure management in further embodiments includes a function for receiving invention disclosures and for time-stamping receipt of received disclosures for date of invention record verification purposes. Also, the invention disclosure module may comprise a facility so that reviewers of an invention disclosure may electronically witness and sign an invention disclosure, such that the signature of the signing witnesses is further date-stamped with data indicating the date of electronic signing.

The invention tracking module in some embodiments is further operable to track potential bar dates relating to national and international filing, based on data entered relating to an offer for sale, public use, publication, or other activities relating to the invention. The module provides notice at various dates to the client of nearing potential bar dates, alerting the client to the potential bar date and the action that must be taken to ensure rights are not lost.

The functions available to the client also include in some embodiments calendar or date tracking functions relating to various activities performed in the course of IP management, such as invention disclosure meetings, attorney meetings, technical review board meetings, etc., and if applicable further track decisions or results of these meetings such as whether to pursue a patent application relating to a specific invention disclosure.

One module of the web-based system usable for client data management, in one embodiment, comprises a data registry of various intellectual property held, such as records relating to trade secret identification and retention, a record of various trademarks and their uses and relevant registration or other legal information, and a patent portfolio log indicating issued patents and their various characteristics such as keyword and subject classification data such that a client may readily view and understand a record of his intellectual property holdings. In a further embodiment of the invention, the web-based system comprises a module operable to search the data relating to these various intellectual property assets, and to produce an intellectual property report or audit.

The client system will in some embodiments include a document system enabling creation or merging of various documents relating to intellectual property matters. License agreements, assignments, non-disclosure agreements, and other such legal documents are examples of documents that may be useful to clients and are included in the various embodiments of the invention.

The client's account data can be readily exchanged with the law firm via the web-management system in some embodiments, such that invention disclosure and potential bar date information relating to a case can be made available to the law firm once the decision to pursue a patent for a particular invention disclosure is made. In further embodiments, the web-based system provides issued patent or other reference search capability in various embodiments to the law firm and to the client for performing and documenting an electronic patentability search and review, so that results of a patentability search relating to an invention disclosure can be stored, and relevant documents recorded for preparation of an Information Disclosure Statement.

Further, in one embodiment, the law firm and the client are capable of exchanging other data via the web-based system, such as submission of a trademark, copyright, or trade secret matter for various purposes, as well as capability to track and coordinate data relating to other matters such as opinion-related issues and work. In one embodiment of the invention, these various intellectual property matters are identified to the client and to the law firm by a matter or activity identifier which need not be the same for both client and law firm, but which identify the same matter and enable identification and specification of data relating to the various matters in which the law firm and client are involved. In addition to matter identifier-based viewing of data, the web-based module in various embodiments comprises activity-based views in which an entity may view the various activities requiring attention for his various matters, may view all matters which have a certain activity pending, or may view another activity-based view of the intellectual property matters under management.

In some embodiments of the invention, the web-based systems used by the client and the law firm are the same computerized system, while in other embodiments they are separate computerized systems but are operable to exchange data as appropriate for proper operation of the invention as described in the above various examples. In some embodiments where the same system is used, various forms of encryption are used to ensure the confidentiality of data as it travels over the Internet or other network. In embodiments where a separate computerized system is utilized by the client, the client may install and configure his own computerized system to host a local web-based system consistent with the present invention such that the client's confidential information such as trade secret information and invention disclosures not released to external entities are held within systems under the client's control. Such systems will be able to exchange data with other computerized data management systems under the client's direction, and so provide the various functions discussed in the example embodiments of the invention presented herein.

Embodiments of the present invention can provide systems and methods for management of intellectual property information, legal information, and/or patent and trademark applications. Various embodiments are described herein with reference to the Figures.

The invention comprises in one embodiment a system for managing patent application data via the Internet, and comprises matter, task, and security modules. The matter module is operable to manage data such as docketing data relating to patent matters, the tasks module is operable to manage tasks related to each matter managed by the matter module, and the security module is operable to restrict access to task and matter data management to selected system users. The system is implemented in some embodiments as a World Wide Web site on the Internet, which in further embodiments comprises various components such as an application server, a Java server, and a database.

### A Three-Tier Architecture

In some embodiments, the present invention can be thought of as a software application designed under a three-tier software architecture paradigm whereby various modules of computer code can be categorized as belonging to one, or more of these three tiers. A three-tier software architecture is well known in the art. (See Applying UML and Patterns: An Introduction to Object-Oriented Analysis and Design and the Unified Process 2^{nd} Edition, by Craig Larman, Prentice Hall, 2002.) The first tier is an Interface level that is relatively free of application processing. The second tier is a Logic level that performs processing in the form of logical/mathematical manipulations (Logical Manipulations) of data inputted, in some embodiments, through the Interface level, and communicates the results of these manipulations with the Interface and/or backend or Storage level. In some embodiments, these Logical Manipulations relate to certain business rules or tasks that govern the application as a whole. In some embodiments, these Logical Manipulations and associated business rules include: the purging of messages in a legal information system, the auto-filing of a result in an IP management system, the obtaining and disseminating of secured on-line data, generating work flow templates, regulating the export control of technical documents, the bulk downloading of documents, billing, creating and managing matter clusters, configuring certain activities, managing independent docket systems, prior art cross citations, and exchange public and private messages, just to name a few. The Storage level is a persistent or, in some embodiments, a non-persistent storage medium. In some embodiments, one or more of these tiers is collapsed into another resulting in a two-tier architecture, or one-tier architecture. For example, the Interface and Logic levels may be consolidated, or the Logic and Storage levels may be consolidated as in the case of an application with an embedded database. This three-tier architecture may be implemented using one technology or, as will be discussed below, a variety of technologies. These technologies may include one or more object orient programming languages such as, for example, Java™, C++, Delphi™, C#™ or the like. Additional structured programming languages such as, for example, C may also be used. Moreover, scripting languages such as, for example, Perl, Python. PHP, JavaScript or VBScript may also be used. This three-tier architecture, and the technologies through which it is implemented, in some embodiments, can be embodied in two or more computers organized in a server-client relationship as is well known in the art. (See Computer Networking: A Top-Down Approach Featuring the Internet 2^{nd} Edition, James F. Kurose and Keith W. Ross. Addison-Wesley, 2003.)

### An Interface Level

In some embodiments, the present invention is implemented using a client based browser application. Some well known client based browser applications include Netscape Browsers™, Internet Explorer™, Mozilla Firefox™, or Opera™ just to name a few. Common to these browser applications, is the ability to utilize a hyper-text transfer protocol (HTTP) or secured hyper-text transfer protocol (HTTPS) to get, upload (i.e, PUT) or delete web pages and interpret these web pages which are written in a hyper-text markup language (HTML) and/or an extensible-markup language (XML). HTTP and HTTPS are well known in the art, as are HTML and XML. (See Id. XML for the World Wide Web, by Elizabeth Castro, Peachpit Press, 2000; Data on the Web: From Relations to Semistructured Data and XML 1^{St} Edition, by Serge Abiteboul, Peter Buneman, & Dan Suciu, Morgan Kaufmann, 1999.) HTTP and HTTPS are, in some embodiments, used in conjunction with a TCP/IP protocol as described in the OSI model, or the TCP Protocol Stack model both of which are well known in the art. (See Computer Networking. A Top-Down Approach Featuring the Internet 2^{nd} Edition, James F. Kurose and Keith W. Ross, 2003.) The practical purpose of the client based browser application is to enable a user to interact with the application through the display of plain text, and/or interactive, dynamic functionality in the form of buttons, text boxes, scroll down bars or other objects contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages, in some embodiments, is a product of the use of other technologies in combination with HTML and/or XML.

In some embodiments, Java Server Pages (JSP™), or Active Server Pages (ASP™ or ASP.NET™) are use to provide a user with dynamic web pages or content via their web browser. In some embodiments, additional technology in the form of an additional program (i.e. routine) written in another programming language is embedded into the HTML and/or XML code allowing for the web pages to become dynamic. Some of these additional technologies include, for example, embedded routines written in the Java™ programming language, the Java Script language, or the Visual Basic™ Programming Language, just to name a few. In some embodiments, these embedded routines are used to execute the aforementioned HTTP, HTTPS requests (i.e., GET, PUT, and DELETE) for web pages. Various types of programming structures such as branches, loops and other types of logic structures are used in such routines. These routines may, in some embodiments, allow a user to login, and request content or upload content.

In some embodiments, a graphical user interface (GUI) is used and is implemented via a Java Servlet, Applet, or VBScript form just to name a few. As will be discussed below, web pages containing GUIs are, in some embodiments, stored at the logical level, but executed at the Interface level via a web browser. These web pages contain objects such as text boxes, buttons, scroll-down bar, just to name few. These objects, and the routines governing them, allow a user to retrieve, input, or delete content just to name a few of the functions. For example, in some embodiments, a user will be prompted with a login page requesting username and password information to be entered into two or more text boxes. Once the data entered into the text boxes is verified, a second, new web page will be requested, interpreted and displayed in the browser application. The verification of the login information will take place at the Logic level outlined below.

### A Logic Level

In some embodiments, the above described Servlet, Applet and/or VBScript form are stored as a JSP™, or ASP™ on one or more remote server computers connected to the client computer via an internet. These remote servers can, in some embodiments, be a web server and/or application server. In some embodiments, web servers running JSP™ can include the Apache™/Apache™ Tomcat web server. In some embodiments, web servers running ASP™ can include Microsoft Windows Web Server 2003™. In some embodiments, application servers running JSP™ can include an Orion Application Server, or J2EE™ Application Server just to name a few. In some embodiments, application servers running ASP™ can include Windows Server 2003™.

In some embodiments, the Logic level is governed by a scripting language that controls how and when certain web pages or pieces of content are provided to, or made accessible to a particular user. This scripting language can be in the form of Java™, Perl, Python or some other general purpose scripting language. For example, once the logic of a JSP™ determines that a particular object (e.g., a text box) on web page has been executed (e.g., a username and password is entered and sent), the data from this text box is inputted, sent to the web or application server. In some embodiments, it is the logic of a routine written in a scripting language that determines what will be sent to the user upon the successful verification of the username and password. In some embodiments, it is the routine written in a scripting language that determines whether, for example, the username and password are valid. In some embodiments, the routine written in a scripting language will serve to retrieve data from a storage, data structure or database level. In some embodiments, the storage level will be a run by a separate database application, while in other embodiments a database embedded with a Logical level will be implemented.

### A Storage Level

In some embodiments, a storage level is implemented whereby tables of data are created, and data inserted into or selected from these tables using a Structured Query Language (SQL) or some other database related language known in the art. (See The Fundamentals of Database Systems 3^{rd} Edition, by Remez Elmasri & Shamkant B. Navathe, Addison-Wesley, 2000.) These tables of data can be managed using a database applications such as, for example, MySQL™, SQL Server™, or Oracle 9i™ or 10g™ just to name a few. These tables, in some embodiments, are organized into a relational-database schema (RDS) or object-relational-database schema (ORDS) as is known in the art. (See id.) In some embodiments, these schemas can be normalized using certain normalization algorithms so as to avoid abnormalities such as non-additive joins and other problems. In some embodiments, these normalization algorithms include Boyce-Codd Normal Form or some other normalization, optimization algorithm known in the art. (See id.) For example, in some embodiments, username and associated password information are stored together such that the scripting routine can compare the inputted, received username and password information to that data stored in the database.

FIG. 1 illustrates one embodiment of a front World Wide Web (WWW) web page of a system consistent with the present invention. A user will log in to the example system shown here by entering a user name at 101, and a password at 102. If a prospective user does not have an account but wishes to create one, the user may do so by selecting to register at 103.

Upon logging in, the user is presented with a home screen presenting the user with various options. For example, the user may be presented with or may select to view his new messages, as is shown generally in FIG. 2. Each message as shown in FIG. 2 includes a message type represented by an icon at 201, an indication of the number of attachments to the message at 202, a matter title indicating a matter related to the message at 203, an indication of who the message is from at 204, a message title at 205, and the time and date the message was received at 206. The user may select a message to view the message, may select a user to send a reply message to the user, may select the message title to display the message, may select the number of attachments indicator to view the attachments, or may take other actions in response to the mew messages screen shown in FIG. 2.

The user may also be presented with or select to view a new tasks screen as shown in FIG. 3, which illustrates new tasks associated with the particular logged in user. Each task has associated data that is displayed in the new tasks view, including the task name at 301, the type of task at 302, the title of the matter the task is related to at 303, the status of the task at 304, and a date associated with the task if appropriate at 305. Tasks may be flagged as shown at 306, so that a user may elect to view only flagged tasks or only new and flagged tasks, thereby viewing a subset of tasks that are of higher importance to the user.

In some embodiments of the invention, the user will be able to generate similar task lists, where the lists are limited to or sorted by client, by date due, by date completed, by status, by type, or by other similar criteria.

Users may also elect from the home page of the example embodiment of the invention described here to view new matters, as shown in FIG. 4. The title of each new matter is shown at 401, and the type of matter is shown at 402. The matter status is shown at 403, and additional matter material may be shown in further embodiments of the invention. As with tasks, users may also view in farther embodiments of the invention other matter summary views similar to the one shown in FIG. 4, such as a view of all matters relating to a particular client, all matters with tasks due during a certain time period, all matters with a certain matter status, or any other such customized matter view.

Matters and users may be associated in some embodiments of the invention with organizations, such as with particular client companies or particular law firms. These organizations are managed by the example embodiment of the system discussed here as is shown in FIG. 5. Each organization is identified by name as shown at 501, and has a type associated with it to identify the nature and role of the organization. The contact or agent for each organization is shown at 503, along with a contact phone number 504 and e-mail address 505 for each contact. Organization data may in some embodiments of the invention be edited or added only by system administrators, and in further embodiments select members who are part of an organization will be given authority to edit existing organization data.

Tasks may be created for matters by manually entering tasks, or in some embodiments of the invention may further be created automatically via templates or other predefined task generation utilities. FIG. 6 illustrates a view of templates available for application to matters in one embodiment of the invention. The template name is shown at 601, and the organization associated with the template is shown at 602. The last modification of the template is reflected at 603 and 604, where the modifying user's identity and the date and time of the last modification are shown. The user has the option to delete existing templates as shown at 606, to create new templates, or to edit existing templates as shown at 605.

Templates include such items as creating checklists to ensure proper drafting criteria are met, creating tasks with associated dates such as deadlines for responses, and other similar tasks that are common to many applications and have predictable elements. For example, a client may request that a certain checklist of drafting criteria be completed before each filing, and the checklist may be implemented as a task associated with each of the client's matters via use of a template. Also, creation of docket dates and tasks associated with those dates in a system such as the present invention may be automatically calculated and created by a template, ensuring proper application of applicable rules. Many other such examples of tasks common to many applications with predictable elements exist, and all are within the scope of the template function as implemented in the example of the present invention presented here.

FIG. 7 illustrates the activities that are associated with an amendment and response to a typical United States Patent and Trademark Office issued Office Action. The typical shortened statutory three-month date for response is shown as an activity item at 701, and is followed by subsequent deadlines for taking each allowable extension of time past that date. These items will then automatically be added to the task list of each matter to which the template is applied, creating appropriate task entries for that matter.

FIG. 8 illustrates a user management view of all users that have registered with the embodiment of the present invention described here. The user name or alias is shown at 801, the entity type is shown at 802, the full name of the entity is shown at 803, and contact information including phone and e-mail are shown at 804 and 805. The user management screen shown here allows a system administrator to delete users at 806, and indicates the source of the user at 807.

An example message list is shown in FIG. 9, which illustrates a variety of messages for a particular user. The subject or name of the message is shown at 901, and the title of the matter to which the message pertains is shown at 902. The sender of the message is shown at 903, and the date the message was received is shown at 904. At 905, the user is shown a Delete object that may be selected to delete the associated message. The type of message is indicated at 906, and the number of attachments to the message are shown at 907. Note that in this example, several automatically generated messages such as reports of actions completed or docket dates are shown in the message box.

FIG. 10 shows a view of tasks or activities associated with a particular matter. The activity is shown at 1001, and is selectable by the user. Selecting the activity by name will open the detail list for that particular activity. Any restrictions on access to the activity are shown at 1002, and the status of the activity is shown at 1003. Relevant dates for the activity, which may vary in type depending on the activity status, are shown at 1004. At 1005, the user may edit or delete listed activities. Because the matter shown here is an issued patent, the patent number, issue date, and other information are known and are displayed at 1006 in a matter page header.

FIG. 11 shows an entities view of a particular selected matter. The parties in interest in this example comprise Intel Corp., as shown at 1101. The law firm associated with the matter is shown at 1102.

The embodiment of the invention shown here also shows additional associated parties, such as corporate counsel responsible for overseeing the matter, the attorney and paralegals involved with the case, and other users or entities involved with the matter. This is shown in FIG. 12, where the associated users are listed at 1201. The role each user has in the matter is shown at 1202, and the status of the user is shown at 1203. Note that a user may be invited to join a matter, but is not listed as active in this embodiment of the invention until the user takes affirmative steps to join in a matter.

FIG. 13 is an IDS documents view of data associated with a matter, and shows documents that must be disclosed in an Information Disclosure Statement or IDS to the USPTO. Because no documents have been associated with this example matter, none are illustrated here. For patent documents that must be cited, the patent number, issue date, country of issue, name, and translation are shown at 1301. For documents that are not patent documents but are other publications, the author's name, document title, citation, referred pages, and publication date are recorded and are shown at 1302.

The example embodiment of the present invention explained above and in the figures is further described in the following use case, which describes ways in which the functionality of the present invention may be used by various users and organizations to facilitate more efficient management of a patent or trademark docket.

The use case system will be used in a decentralized way as a web-based application where multiple law-firms and corporations, as well independent lawyers and consultants, can all come together to collaborate on patents in which they are involved.

The service provider will deal with various law-firms and corporations to create a community where patents filing process can be vastly streamlined. All such law firms and corporations (referred to as ‘Business entities’) will be dealing directly with the service provider (sending all the materials to be scanned, etc. to them). There will be an administrator at the service provider, who will be to verify business entities details and assign them a account number (provided by our system).

The business entities will assign an account administrator who will be responsible for managing who participates on behalf of the entity in the patent process. The business entity does this by sending an invitation to a prospective participant with an access code that allows him to access information relating to the business entity. In this process, the administrator may also authorize such participant to charge matter and other related costs to specified account number. Membership in groups is regulated such that anyone can create a user account and associated login. This person can then create a new matter to be managed via the service provider's web site, and can specify other participants for that matter. The service provider then sends e-mail to these invited participants with an invitation to join and a password or secure link. An invitee can then log in, and select to access the matter from his matters list, and supply a password received in the e-mail to associate the new matter with his particular user account and matters list. One example involves an attorney who logs on, opens a new matter, then sends invitations to inventor, paralegals, etc. For each one of these, he provides an email address to which an invitation is sent, and a password with which the invited users can access the matter. Inventor gets email with a site URL, matter number and password. When he clicks it, he is required to sign in. When he gets to my matters, he presses ‘Access New Matter’ button, which asks him for matter number and password. He fills in this information from what he received by email. This matter is now made available on his matter list.

In a second example scenario, Thomas Edison signs up with the service, and creates a new matter. He fills in notes regarding the invention and other information, and finally decides on an attorney or law firm to work with. He sends invitations to selected attorneys there. The attorney accepts the invitation, and then sends out additional invitations to paralegals and other associated users.

In a third scenario, Idle Joe signs up, and goes to ‘My matters’. He sees nothing there. He cannot access any existing matters to which he has not been invited. He opens a new matter, and plays around with the functions provided by the website. He realizes there's nothing at the service provider for him, then logs off and goes on to cause trouble elsewhere. New users who do not have any associated matters and are not members of any group will periodically have their accounts deactivated to ensure smooth operation of the service provider system.

This use case example further provides billing functionality. The service provider provides the option of billing for each open matter, and allows creating billing entries for services associated with a matter, such as docketing, prior art searches, drafling, drawing preparation, or other related services or products.

The service provider's system is configured such that the entities that interact with the system are categorized into individuals, businesses, clients, law firms, the USPTO, and the service provider, as explained in greater detail below.

Individuals includes ordinary individual users who could be attorneys working for a law-firm, independent attorneys, employees of corporations, independent consultants, paralegals, etc. In short, it includes any person who is involved or expected to be involved in the managing of a matter through to completion.

Business entities allows several individuals to participate in the process under the same umbrella. Two types of Businesses are recognized: Client, and Law Firm businesses. A Client participates as a requester of patent services and law firm acts as provider of such services.

Clients are the entities that are seeking patent services. The client can be a corporation, university, or other entity, and essentially defines a grouping of individuals who can share information that is common to them by virtue of their association with the client entity. For example, a corporation will have a preferred set of law firms, a preferred set of foreign associates, and other preferences and relationships. An account administrator for the corporation can assign privileges to different people for different pieces of information associated with the Corporation.

A law firm is a grouping of individuals, including lawyers, paralegals, and other individuals who can share information common to them by virtue of their association with a legal services provider. For example, lists of client companies and information about individuals within them is information may be accessible to various degrees throughout a law firm. A law firm administrator can invite people to be members of the law firm group and give privileges to them for access to various information.

Still other entities may be created and invited to participate in a matter to facilitate patent legal services. The United States Patent and Trademark Office and select examiners may be given certain access to relevant matters, outside service providers such as scanning service providers may be given access to certain data, and the service provider operating the website may have varying degrees of access to data.

The service provider will desirably manage the various accounts and grouping of entities, and provide customer support for the various services and functions of the website. The service provider will not only have access to certain data, but will be able to determine billing for services provided via the website, account information of the member entities, and will have account management capability.

The various matters managed via the service provider include a client name, a client contact name, a law firm or service provider name, a law firm matter number, a client reference number, a unique reference number provided by the service provider, a foreign associate for various corresponding foreign filings, and identification of the various law firm members assigned to the matter. Law firm roles include billing attorney, working attorney, signature attorney, paralegal, docketing specialist, IDS specialist, and various secretaries that may be associated with the other law firm members.

Individuals can have one or more roles in a client organization, and may belong to several organizations or groups via a single user name or login ID. It is anticipated that a typical individual will serve various roles in a number of different matters, and will have access via a single login or user ID to information related to each of the various matters with which he is associated.

Business entities may further have approved lists of law firms, foreign associates, and other approved entities. Individual attorneys may also be approved, and lists of individuals working with the business entity matters within other entities may be used.

For this use case example, assume an administrator representing a business or corporate entity desires to use the service provider to manage patent-related legal services. The administrator creates a new account within which matters created by its approved members can be created, managed, and billed. The business account manager can add new law firms, attorneys, foreign associates, business representatives, inventors, and other members. The business account administrator can further deactivate or remove various members from the business account or matters owned by the business account, and can generate reports and retrieve information relating to the various matters and entity involvement in the matters owned by the business account.

A law firm entity will have the ability to create new client records, including invitation to business entities to join matters or create accounts. The law firm will also have the ability to enter billing and fee data, including calculation of fees for particular services or hourly rates, and entry of fee codes and billing descriptions. The law firm further can invite new users to be members of the law firm, assign users to roles within specific matters, and manage the role of various users within the law firm and within matters with which the law firm is associated.

Individuals will be able to join existing business groups, law firms, or other entities with the approval of the entity. Association with an entity may be ad the individual's request, or by invitation from the entity. Each individual, whether a member of another entity or not, will be able to create matters, invite others to participate in the matters, receive and send e-mail regarding the matters, and view the status of his matters. The individual can create or update notes associated with his matters, check outstanding actions or dates for his matters, generate matter reports, print documents, and browse other information relating to his matters. This information includes viewing invited and associated entities for each matter, viewing matter task information, viewing billing or invoice information, viewing related case information, and viewing docketing information.

The individual will also be able to copy, delete, remove, archive, or verify matters, and will be able to search for matter information via law firm docket number, client name, serial number, prior docket number, related case number, inventor name, and other information. The matters will have a notes or discussion area for maintaining matter-related notes, and will have data records enabling automated e-mail reminders of actions due and case status.

Trademarks may be managed as matters, and will have information including the actual trademark sought, action data, country-related data, conflict opposition data, auxiliary files or tables, reports, recurring date menus, utility menus, agent details, and country details. Managed patents will similarly have record space configured for storing invention or disclosure data, country application data, actions due or docketing data, auxiliary files and tables, reports, maintenance fee data, utility menus, actions menus, and cost tracking and budgeting data.

Information disclosure statement (IDS) records are associated with various other matters such as filed or unfiled patent applications, and are managed via functions that include the ability to copy documents to or from other matters to which the user has access, to delete or add documents associated with a particular matter, to combine references cited from various matters, to scan or view images of various references, to view US patent documents by patent number, title, or other identifier, to view foreign patent documents, to view non-patent documents, or to view all associated documents. Documents associated with an IDS may be marked as relevant or not relevant, or may be unmarked. The documents associated with an IDS for a particular matter may therefore be viewed, printed, merged, sorted, or otherwise managed based on whether they are marked relevant, marked not relevant, or unmarked.

Marked documents may be merged into forms such as a standard form 1449 for citing relevant known art to the USPTO. Documents that have been cited are marked separately from those that have been marked but not yet sent, to enable accurate tracking and determination of which documents have been cited and which documents are yet to be cited.

Each IDS reference document will have associated records that enable accurate identification of the document, such as US patent number, foreign patent number, issue date, priority date, inventor names or author names, publication name or other citation of non-patent publications, and title. It is desired that the records associated with each IDS reference be sufficient to meet the formal reporting requirements in citing the document to the USPTO via a form 1449 or other appropriate method.

Some members, such as scanning centers, may have very limited capabilities relative to a typical member or entity. A scanning center, for example, may be limited to uploading scanned data to be associated with a particular matter, entering billing or invoice charges and descriptions, and generating reports of uploaded data and billing charges.

Finally, in a use case such as that described here, a business entity or other client can easily change law firms, attorneys, or the role of other members in various matters managed via the service provider with minimal effort or expense.

### System and Method for Billing

Embodiments of the present invention provide a system that allows for the economic recovery of professional service costs associated with electronic communications. As an example, the transformation of the legal profession from traditional paper-based communication to electronic communications creates difficulty in accurately billing for an attorney's service time reading and writing e-mails.

In the inventive data processing system, as described above with reference to intellectual property services, the data is organized according to activities related to intellectual property. Each intellectual property activity is represented by an activity data structure containing at least some data pertinent to the activity, such as professional services billing.

Referring to FIG. 14, a system 1400 having a data management system 1410 can process e-mails and store documents 1430, as explained above. A user interface 1440 allows users to access the data system. In one embodiment of the present invention electronic messages, or e-mails, can be sent or received from a mail handling system 1420 such that the message is received or stored in a data management system. For example, the data management system may be implemented by an attorney or professional legal service. The embodiment provides for automatically associating the message with a matter represented in the data management system, as described above in greater detail. The email communications are processed to allow automatic billing for clients 1450.

In one embodiment 1500, as illustrated in FIG. 15, when an e-mail is written, sent or received 1510 the data management system displays a user selectable item. For example, a selectable icon (generically referred to as an item) is displayed on a computer monitor screen that the user can activate. The item is displayed during drafting of an e-mail, upon sending the e-mail and/or when an external e-mail is received. Upon activating the item a data entry routine, or operation, is executed that presents a data entry screen to the user 1520. Billing is initiated either manually or automatically 1530 to create a billing entry 1540 in the management system. The data entry screen allows the user to enter and edit professional billing information. For example, in the legal profession embodiment attorney time associated with electronic correspondences can be entered into the data base and automatically associated with the legal matter in which the electronic message is associated. In yet another embodiment, a billing code is associated with the billing entry. For example, a ‘reading e-mail’ or ‘preparing e-mail’ billing code is associated with the appropriate billing entry.

The above described embodiments of the present invention allow for fast accurate real-time entry of professional service fees associated with processing electronic communications.

Although specific embodiments of the present invention have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method comprising:
receiving a message from a mail handling system wherein the message is received in an intellectual property management system;
automatically associating the message with a legal matter represented in the intellectual property management system; and
displaying a user selectable item with the message when it is displayed to a user, wherein user selection of the item executes a data operation, wherein the data operation includes displaying a data entry screen to accept a time entry, wherein the time entry is automatically associated with the legal matter in which the message is associated.

2. A method comprising:
organizing intellectual property data according to activities related to intellectual property, wherein each activity is represented by an activity data structure containing at least some data pertinent to the activity, and further wherein the activity data structure associates legal billing data associated with the activity; and
adding a legal services billing entry to an activity data structure using a user selectable item displayed while an electronic communication associated with the activity data structure is displayed to a user.

3. The method according to claim 2 further includes selecting a billing code associated with the legal services billing.

4. A method for entering billing entries for legal services comprising:
executing a billing entry operation while a user is processing an electronic communication; and
displaying a form on a monitor to the user, wherein the form includes locations to enter time and descriptions for more than one billing entries associated with a particular legal matter.

5. A computer implemented legal services data processing system comprising:
data organized in a client, matter and activity hierarchical format, wherein a client comprises a plurality of matters and each of the plurality of matters comprises a plurality of activities; and
an executable data entry routine which can be activated in response to a user while the user is processing an electronic message associated with a selected activity, wherein the executable data entry routine allows the user to enter billing information corresponding to the selected activity.

6. A method comprising organizing intellectual property data according to activities related to intellectual property management, wherein:
the activities are represented by an activity data structure operable on a computer through a computer user interface; and
the activity data structure comprising a user interface screen configured to activate the computer to take action with regard to the activities, wherein docket tasks are associated through the data structure with the activities.

7. A method comprising organizing intellectual property data according to activities related to intellectual property management, wherein the activities are represented by an activity data structure configured to activate the computer to take action with regard to the activities, wherein docket tasks are associated through the data structure with the activities.

8. A method for managing patent application data, comprising implementing a computer-executable screen presentation capable of associating at least one matter with a client entity having an interest in the matter.

9. The method of claim 1 wherein the data entry screen presentation comprises data fields for displaying applicable data.

10. The method of claim 9, wherein a plurality of the data fields are presented in rows and columns which cross one another, wherein:
a separate row displays data across the columns;
any single row displays data applicable to a particular entity;
one of the columns in a separate row comprises and entity column configured for displaying one or more particular entities; and
others of the columns in the same separate row are configured to identify other applicable data related to the entity displayed in the entity column.

11. The method of claim 10, wherein the other applicable data comprises one or more of notes, a role played by the entity, a file number, a billing number, a contact person, and a related action.

12. A system for managing patent application data, comprising:
a matter module, the matter module operable to manage data relating to patent matters, the managed data comprising docketing data;
a tasks module, the tasks module operable to manage tasks related to each matter managed by the matter module, the tasks comprising docketing tasks;
a security module, the security module operable to restrict access to task and matter data management to selected system users; and
an entities module, the entities module operable to manage applicable parties having an interest in the patent application data.

13. A method comprising organizing intellectual property data according to activities related to intellectual property management, wherein:
the activities are delineated in a spread sheet having rows and columns;
there is a column labeled with the term “activity” or with one or more terms having a similar meaning;
each row may be labeled with an activity in the “activity” column; and
the spaces defined when other rows cross other columns are suitable to contain other suitable information as applicable based on the labeled title of the other respective rows and columns.

14. The method of claim 13, wherein one of the other columns is entitled “description/comments” or with one or more terms having a similar meaning.

15. The method of claim 13, wherein another of the other columns is entitled “status” or with one or more terms having a similar meaning.

16. The method of claim 13, wherein still another of the other columns is entitled “date 1” or with one or more terms having a similar meaning.

17. The method of claim 13, wherein still another of the other columns is entitled “date 2” or with one or more terms having a similar meaning.

18. The method of claim 13, wherein one or more of the other columns are entitled “description/comments”, “status”, “date 1”, and “date 2” or with other terms of similar meaning.

19. A method comprising organizing intellectual property data according to activities related to the intellectual property, wherein:
each activity is represented by an activity data structure:
organized in columns and rows; and
containing at least some data pertinent to the activity;
there being one or more columns labeled by one or more of headings or equivalent headings as follows:
activity;
description/comments;
status;
date 1;
date 2; and
there being a row across one or more of the columns for entry of data for one or more of a particular activity, its description/comments, status, date 1, and date 2.

20. A computer-implemented method comprising:
organizing intellectual property data on a computer display according to activities related to an intellectual-property matter, wherein
the activities are delineated in a spread sheet having a plurality of columns and a plurality of rows including a first row and a second row of the plurality of rows, wherein each of the plurality of rows displays a plurality of attributes of one of the activities arranged across the plurality of columns;
one of the displayed attributes in the first row includes a label of a first intellectual-property activity in one of the columns;
the other displayed attributes in other columns of the first row contain other suitable information relating to the labeled activity;
one of the displayed attributes in the second row includes a label of another particular intellectual-property activity in the one of the columns; and
the other displayed attributes in other columns of the first row contain other suitable information relating to the labeled activity.

21. The method of claim 20 further comprising eliciting and receiving user input in the first row to direct performance of an action regarding the first activity.

22. The method of claim 20, wherein the eliciting and receiving user input includes displaying the label of a first intellectual-property activity as a hyperlink, and wherein the performance of the action includes displaying other data relevant to the first activity upon a click of the hyperlink.

23. The method of claim 20, wherein the eliciting and receiving user input includes displaying a plurality of icons in the first row, and wherein the performance of the action includes performance of an action symbolized by each displayed icon.

24. The method of claim 20, wherein the eliciting and receiving user input includes displaying a hyperlink to an edit function in the first row, and wherein the performance of the action includes eliciting and receiving user input to edit the first activity.

25. The method of claim 20, wherein the eliciting and receiving user input includes displaying a drop-down menu of at least one selectable task in the first row, and wherein the performance of the action includes adding a selected task to the first activity.

26. The method of claim 20, wherein the eliciting and receiving user input includes displaying a hyperlink to an add function, and wherein the performance of the action includes adding a third activity in a third row.

27. The method of claim 20 wherein one of the other displayed attributes in the first row includes description and comments regarding the first activity.

28. The method of claim 20 wherein another one of the other displayed attributes in the first row includes a status regarding the first activity.

29. The method of claim 20 wherein still another of the other displayed attributes in the first row includes a first date regarding the first activity.

30. The method of claim 20 wherein still another of the other displayed attributes in the first row includes a second date regarding the first activity.

31. The method of claim 20 wherein the spread sheet includes a header row that labels columns with descriptive terms denoting displayed attributes of the respective columns including columns for activity, description/comments, status, date 1, and date 2.

32. A method comprising:
organizing intellectual property data according to activities related to the intellectual property, wherein each activity is represented by an activity data structure that is associated with the intellectual property;
displaying data pertinent to each of a plurality of activities related to the intellectual property organized in a plurality of columns and a plurality of rows, each row containing at least some data pertinent to a selected activity; wherein the plurality of columns are each labeled by one or more descriptive headings, the columns for each one of the plurality of rows including attributes for an activity label, description/comments pertinent to the labeled activity, a status of the activity, a date 1 pertinent to the activity, and a date 2 pertinent to the activity; and
displaying in each of the plurality of rows a user-input mechanism for entry of data pertinent to a particular activity associated with that row.

33. A computer-readable medium having instructions stored thereon for causing a suitably programmed computer to perform a method comprising:
organizing intellectual property data on a computer display according to activities related to an intellectual-property matter, wherein the activities are delineated in a spread sheet having a plurality of columns and a plurality of rows including a first row and a second row of the plurality of rows, wherein each of the plurality of rows displays a plurality of attributes of one of the activities arranged across the plurality of columns;
one of the displayed attributes in the first row includes a label of a first intellectual-property activity in one of the columns;
the other displayed attributes in other columns of the first row contain other suitable information relating to the labeled activity;
one of the displayed attributes in the second row includes a label of another particular intellectual-property activity in the one of the columns; and
the other displayed attributes in other columns of the first row contain other suitable information relating to the labeled activity.

34. The computer-readable medium having instructions stored thereon for causing a suitably programmed computer to perform the method of claim 33, further comprising eliciting and receiving user input in the first row to direct performance of an action regarding the first activity.

35. The computer-readable medium having instructions stored thereon for causing a suitably programmed computer to perform the method of claim 33, wherein the eliciting and receiving user input includes displaying the label of a first intellectual-property activity as a hyperlink, and wherein the performance of the action includes displaying other data relevant to the first activity upon a click of the hyperlink.

36. The computer-readable medium having instructions stored thereon for causing a suitably programmed computer to perform the method of claim 33, wherein the eliciting and receiving user input includes displaying a plurality of icons in the first row, and wherein the performance of the action includes performance of an action symbolized by each displayed icon.

37. The computer-readable medium having instructions stored thereon for causing a suitably programmed computer to perform the method of claim 33, wherein the eliciting and receiving user input includes displaying a hyperlink to an edit function in the first row, and wherein the performance of the action includes eliciting and receiving user input to edit the first activity.

38. The computer-readable medium having instructions stored thereon for causing a suitably programmed computer to perform the method of claim 33, wherein the eliciting and receiving user input includes displaying a drop-down menu of at least one selectable task in the first row, and wherein the performance of the action includes adding a selected task to the first activity.

39. The computer-readable medium having instructions stored thereon for causing a suitably programmed computer to perform the method of claim 33, wherein the eliciting and receiving user input includes displaying a hyperlink to an add function, and wherein the performance of the action includes adding a third activity in a third row.

40. The computer-readable medium having instructions stored thereon for causing a suitably programmed computer to perform the method of claim 33, wherein one of the other displayed attributes in the first row includes description and comments regarding the first activity.

41. The computer-readable medium having instructions stored thereon for causing a suitably programmed computer to perform the method of claim 33, wherein another one of the other displayed attributes in the first row includes a status regarding the first activity.

42. The computer-readable medium having instructions stored thereon for causing a suitably programmed computer to perform the method of claim 33, wherein still another of the other displayed attributes in the first row includes a first date regarding the first activity.

43. The computer-readable medium having instructions stored thereon for causing a suitably programmed computer to perform the method of claim 34, wherein still another of the other displayed attributes in the first row includes a second date regarding the first activity.

44. The computer-readable medium having instructions stored thereon for causing a suitably programmed computer to perform the method of claim 34, wherein the spread sheet includes a header row that labels columns with descriptive terms denoting displayed attributes of the respective columns including columns for activity, description/comments, status, date 1, and date 2.

45. A computer-readable medium having instructions stored thereon for causing a suitably programmed computer to perform a method comprising:
organizing intellectual property data according to activities related to the intellectual property, wherein each activity is represented by an activity data structure that is associated with the intellectual property;
displaying data pertinent to each of a plurality of activities related to the intellectual property organized in a plurality of columns and a plurality of rows, each row containing at least some data pertinent to a selected activity;
wherein the plurality of columns are each labeled by one or more descriptive headings, the columns for each one of the plurality of rows including attributes for an activity label, description/comments pertinent to the labeled activity, a status of the activity, a date 1 pertinent to the activity, and a date 2 pertinent to the activity; and
displaying in each of the plurality of rows a user-input mechanism for entry of data pertinent to a particular activity associated with that row.

46. An apparatus comprising:
an information processing system including a database containing data pertinent to the intellectual-property matter, and a display driver, wherein the display driver is configured to generate display data to cause display of the activities delineated in a spread-sheet format having a plurality of columns and a plurality of rows including a first row and a second row of the plurality of rows, and wherein:
each of the plurality of rows displays a plurality of attributes of one of the activities arranged across the plurality of columns;
one of the displayed attributes in the first row includes a label of a first intellectual-property activity in one of the columns;
the other displayed attributes in other columns of the first row contain other suitable information relating to the labeled activity;
one of the displayed attributes in the second row includes a label of another particular intellectual-property activity in the one of the columns; and
the other displayed attributes in other columns of the first row contain other suitable information relating to the labeled activity.

47. An apparatus comprising:
an information processing system configured to organize data pertinent to intellectual property according to activities related to the intellectual property, wherein each activity is represented by an activity data structure that is associated with the intellectual property;
a display driver operatively coupled to receive data pertinent to the intellectual property and configured to generate display data regarding each of a plurality of activities related to the intellectual property organized in a plurality of columns and a plurality of rows, each row containing at least some data pertinent to a selected activity, there being one or more columns each labeled by one or more descriptive headings, the columns for each one of the plurality of rows including attributes for an activity label, description/comments pertinent to the labeled activity, a status of the activity, a date 1 pertinent to the activity, and a date 2 pertinent to the activity.

48. The apparatus of claim 46, further comprising the information processing system:
organizing intellectual property data on a computer display according to activities related to an intellectual-property matter, wherein the activities are delineated in a spread sheet having a plurality of columns and a plurality of rows including a first row and a second row of the plurality of rows, wherein each of the plurality of rows displays a plurality of attributes of one of the activities arranged across the plurality of columns;
one of the displayed attributes in the first row includes a label of a first intellectual-property activity in one of the columns;
the other displayed attributes in other columns of the first row contain other suitable information relating to the labeled activity;
one of the displayed attributes in the second row includes a label of another particular intellectual-property activity in the one of the columns; and
the other displayed attributes in other columns of the first row contain other suitable information relating to the labeled activity.

49. The apparatus of claim 46, further comprising the information processing system eliciting and receiving user input in the first row to direct performance of an action regarding the first activity.

50. The apparatus of claim 46, further comprising the information processing system eliciting and receiving user input that includes displaying the label of a first intellectual-property activity as a hyperlink, and wherein the performance of the action includes displaying other data relevant to the first activity upon a click of the hyperlink.

51. The apparatus of claim 46, further comprising the information processing system eliciting and receiving user input that includes displaying a plurality of icons in the first row, and wherein the performance of the action includes performance of an action symbolized by each displayed icon.

52. The apparatus of claim 46, further comprising the information processing system eliciting and receiving user input that includes displaying a hyperlink to an edit function in the first row, and wherein the performance of the action includes eliciting and receiving user input to edit the first activity.

53. The apparatus of claim 46, further comprising the information processing system eliciting and receiving user input that includes displaying a drop-down menu of at least one selectable task in the first row, and wherein the performance of the action includes adding a selected task to the first activity.

54. The apparatus of claim 46, further comprising the information processing system eliciting and receiving user input that includes displaying a hyperlink to an add function, and wherein the performance of the action includes adding a third activity in a third row.

55. The apparatus of claim 46, wherein one of the other displayed attributes in the first row includes description and comments regarding the first activity.

56. The apparatus of claim 46, wherein another one of the other displayed attributes in the first row includes a status regarding the first activity.

57. The apparatus of claim 46, wherein still another of the other displayed attributes in the first row includes a first date regarding the first activity.

58. The apparatus of claim 46, wherein still another of the other displayed attributes in the first row includes a second date regarding the first activity.

59. The apparatus of claim 46, wherein the spread sheet includes a header row that labels columns with descriptive terms denoting displayed attributes of the respective columns including columns for activity, description/comments, status, date 1, and date 2.

60. The apparatus of claim 46, further comprising the information processing system:
organizing intellectual property data according to activities related to the intellectual property, wherein each activity is represented by an activity data structure that is associated with the intellectual property;
displaying data pertinent to each of a plurality of activities related to the intellectual property organized in a plurality of columns and a plurality of rows, each row containing at least some data pertinent to a selected activity;
wherein the plurality of columns are each labeled by one or more descriptive headings, the columns for each one of the plurality of rows including attributes for an activity label, description/comments pertinent to the labeled activity, a status of the activity, a date 1 pertinent to the activity, and a date 2 pertinent to the activity; and
displaying in each of the plurality of rows a user-input mechanism for entry of data pertinent to a particular activity associated with that row.

61. The apparatus of claim 46, further comprising:
a user-input facility visually associated with each displayed row and configured to receive entry of data pertinent to a particular activity associated with that row.

62. A computer readable medium having instructions stored thereon for causing a suitably programmed computer to perform the following method comprising:
generating in a graphical user interface an application window having a window frame and a plurality of stiles to define a plurality of panes within the frame;
displaying in a first pane user selectable tasks;
displaying in a second pane task status information;
displaying in a third pane invention title information; and
displaying in a fourth pane invention date information.

63. A computer readable medium having instructions stored thereon for causing a suitably programmed computer to perform the following method comprising:
generating in a graphical user interface an application window having a window frame and a plurality of stiles to define a plurality of panes within the frame;
displaying in a first pane a message date;
displaying in a second pane a message sender; and
displaying in a third pane invention a message title.

64. A computer readable medium having instructions stored thereon for causing a suitably programmed computer to perform the following method comprising:
generating in a graphical user interface an application window having a window frame and a plurality of stiles to define a plurality of panes within the frame;
displaying in a first pane an activity title;
displaying in a second pane an activity status; and
displaying in an third pane an activity date.
